(19) United States
(12) Patent Application Publication
(10) Pub. No.: US 2026/0274177 A1
(43) Pub. Date: Sep. 17, 2026

(54) COMPONENT FOR VEHICLE INTERIOR

(71) Applicant: Yanfeng International Automotive Technology Co. Ltd., Novi, MI (US)

(72) Inventors: Liyong WANG, Shanghai (CN); Jie SHI, Shanghai (CN); Jie SUN, Shanghai (CN); Leilei WANG, Shanghai (CN); Jing GU, Shanghai (CN)

(21) Appl. No.: 19/665,640

(22) Filed: May 1, 2026

Related U.S. Application Data
(63) Continuation-in-part of application No. PCT/CN2024/128481, filed on Oct. 30, 2024.

(30) Foreign Application Priority Data
Nov. 1, 2023 (CN) 202311443381.6

(51) Int. Cl. B60R 13/02; B32B 27/36

(52) U.S. Cl. CPC B60R 13/02; B32B 27/36; B32B 2255/10; B32B 2255/26; B32B 2274/00; B32B 2307/538; B32B 2307/584; B32B 2605/003

(57) ABSTRACT

A component for a vehicle interior comprising a composite structure is disclosed. The composite structure may comprise a substrate/base and cover comprising base layer and cover layer configured to provide a surface effect such as visual effect and/or performance effect. The cover layer may comprise an applied material, formed/molded material, coating, treatment, laminate, film, etc.; the base layer may comprise a formed/molded material, polymer material, thermoplastic elastomer, foam/soft material, etc. The composite structure may comprise a multi-layer structure comprising a polymer material, fabric layer, non-woven layer, formed/molded materials, soft/cushion layer, barrier/intermediate layer in/at the cover, coating/treatment layer, etc. The substrate may comprise a structural substrate, formed/molded structure, panel, formed/molded panel, fiber panel, foam/resilient panel, composite panel, etc. The surface effect may comprise liquid repellence, durability/wear resistance, scratch resistance, stain resistance, anti-fouling, touch-feel/tactile performance, hardness/softness, friction coefficient, adhesion, decorative/color effect, etc. A method of making the composite structure is disclosed.

### CROSS-REFERENCE TO RELATED APPLICATIONS

The present application is a continuation-in-part of PCT/International Patent Application No. PCT/CN2024/128481 titled “SKIN MATERIAL FOR VEHICLE AND VEHICLE TRIM COMPRISING SKIN MATERIAL” filed Oct. 30, 2024, which claims the benefit of Chinese Patent Application No. 202311443381.6 titled “SKIN MATERIAL FOR VEHICLE AND VEHICLE TRIM COMPRISING SKIN MATERIAL” filed Nov. 1, 2023.

The present application claims priority to and incorporates by reference in full the following patent applications: (1) PCT/International Patent Application No. PCT/CN2024/128481 titled “SKIN MATERIAL FOR VEHICLE AND VEHICLE TRIM COMPRISING SKIN MATERIAL” filed Oct. 30, 2024; and (2) Chinese Patent Application No. 202311443381.6 titled “SKIN MATERIAL FOR VEHICLE AND VEHICLE TRIM COMPRISING SKIN MATERIAL” filed Nov. 1, 2023.

The present application relates to and incorporates by reference in full the following patent applications/documents: (1) PCT/International Patent Application No. PCT/CN2024/128481 titled “SKIN MATERIAL FOR VEHICLE AND VEHICLE TRIM COMPRISING SKIN MATERIAL” filed Oct. 30, 2024; and (2) Chinese Patent Application No. 202311443381.6 titled “SKIN MATERIAL FOR VEHICLE AND VEHICLE TRIM COMPRISING SKIN MATERIAL” filed Nov. 1, 2023; (3) U.S. patent application Ser. No. 19/658,662 titled “VEHICLE INTERIOR COMPONENT” filed Apr. 26, 2026; (4) PCT/International Patent Application No. PCT/CN2024/127326 titled “MULTI-LAYER MATERIAL AND MANUFACTURING METHOD THEREFOR” filed Oct. 25, 2024; and (5) Chinese Patent Application No. 202311406760.8 titled “A MULTILAYER MATERIAL AND A METHOD FOR PREPARING THE SAME” filed Oct. 26, 2023.

### FIELD

The present invention relates to a composite structure for a component for a vehicle interior.

The present invention also relates to a composite structure for a component for a vehicle interior comprising a substrate/base and a cover comprising a cover layer and a base layer.

### BACKGROUND

It is known to provide a composite structure for a component for a vehicle interior comprising a substrate/base and a cover.

It would be advantageous to provide an improved composite structure for a component for a vehicle interior comprising a substrate/base and cover comprising a base layer and a cover layer configured to provide a surface effect such as a visual effect and/or a performance effect.

### SUMMARY

The present invention relates to a component for a vehicle interior comprising a composite structure; the composite structure may comprise a substrate; the substrate may comprise a structural substrate; the composite structure may comprise a cover provided on the substrate; the cover may comprise a base layer and a cover layer; the cover layer may comprise an exterior surface; the cover may be configured to provide a surface effect at the exterior surface; the surface effect may comprise a visual effect and/or a performance effect. The performance effect may comprise stain resistance and/or fluid repellence and/or hardness and/or softness and/or scratch resistance and/or tactile performance and/or antifouling; the surface effect may comprise adhesion evaluation and/or wear resistance and/or stain resistance evaluation and/or water droplet angle and/or feel evaluation and/or texture and/or static friction coefficient and/or dynamic friction coefficient; the visual effect may comprise color and/or texture effect and/or grain effect; the performance effect may be provided by the cover layer and/or the base layer; the cover layer may comprise a coating; the cover layer may be formed on the base layer; the cover layer may comprise a molded layer and/or an injection molded layer and/or a foam molded layer and/or a skin layer; the base layer may comprise a molded layer; the molded layer may comprise a polymer material and/or a molded material and/or an injection-molded material and/or a film and/or a polymer material and/or an elastomer and/or a thermoplastic elastomer and/or TPEE and/or TPU and/or TPV and/or TPE-S; the cover layer may comprise a polymer material and/or a molded material and/or an injection-molded material and/or a film and/or a polyurethane material and/or an acrylic material comprising silicone and/or a polymer material comprising fluorine and/or a stain-resistant polymer material and/or polyacrylate and/or polyurethane and/or aziridine and/or isocyanate and/or carbodiimide and/or polyacrylic acid and/or methyl carboxylic acid methyl cellulose and/or acrylic fluoropolymer and/or organosiloxane polymer; the structural substrate may comprise a panel and/or a base and/or a fiber panel and/or a compressed fiber panel and/or a reduced-density material and/or a stiffness-retaining material and/or a molded substrate and/or a composite panel and/or polymer material and/or a structure and/or hemp fiberboard and/or foamed hemp fiberboard and/or foamed glass fiberboard and/or polypropylene and/or polyimide and/or polycarbonate; the cover may comprise a polymer material; the polymer material may comprise a thermoplastic polyester elastomer comprising a hard segment and a soft segment; the polymer material may be configured for recyclability as a sub-assembly and the polymer material may be selected from a group of polymer materials comprising a polyolefin group and/or a thermoplastic elastomeric group and/or an elastomeric group; the cover layer may comprise a film and/or a coating and/or an exterior layer; the coating may comprise a film-forming agent and a crosslinking agent and/or a solvent and an anti-fouling agent and/or a solvent and a leveling agent and/or a solvent and a silane-based auxiliary agent and/or water or ethanol or isopropanol or a combination and/or polyacrylate or polyurethane or a combination and/or aziridine or isocyanate or carbodiimide or a combination and/or polyacrylic acid or methyl carboxylic acid methyl cellulose or a combination and/or an acrylic fluoropolymer or an organosiloxane polymer or a combination; the performance effect may comprise liquid repellence and/or scratch resistance and/or stain resistance and/or abrasion resistance and/or gloss retention and/or a friction coefficient and/or adhesion and/or anti-fouling and/or weather resistance and/or a water droplet angle; the base layer may comprise a polyethylene terephthalate fiber material and/or a nonwoven fabric material and/or a mesh fabric and/or foam material and/or sponge material and/or thermoplastic polyester elastomer and/or a foamed material and/or polyethylene terephthalate fiber nonwoven fabric; the cover may comprise thermoplastic polyester elastomer and/or thermoplastic vulcanized rubber and/or polyurethane and/or a self-skinned material formed from thermoplastic polyester elastomer and/or a resilient material and/or a compressible material and/or a cushioning material and/or a foam material and/or a foam-based material and/or a film and/or polypropylene and/or polyethylene and/or polyethylene terephthalate and/or thermoplastic polyurethane elastomer and/or thermoplastic polyester elastomer and/or a laminate with the structural substrate and/or a skin layer formed from a thermoplastic polyester elastomer by an injection molding process and/or a coating on the base layer; the intermediate layer may comprise polypropylene and/or polyethylene and/or polyethylene terephthalate and/or thermoplastic polyurethane elastomer and/or thermoplastic polyester elastomer and/or a barrier layer the barrier layer may comprise a material configured to limit penetration of material of the cover layer into material of the base layer during formation of the cover; the barrier layer may comprise a material having compatibility with material of the cover layer; and the barrier layer may comprise a laminate with the base layer.

The present invention relates to a component for a vehicle interior comprising a composite structure; the composite structure may comprise a substrate; the substrate may comprise a structural substrate; the composite structure may comprise a cover provided on the substrate; the cover may comprise a base layer and a cover layer; the cover layer may comprise an exterior surface; the cover may be configured to provide a surface effect at the exterior surface; the surface effect may comprise a visual effect and/or a performance effect. The component may be produced by a method comprising the steps of providing a base layer material for the base layer of the cover, providing the cover layer material for the cover layer on the base layer and providing the cover on the structural substrate; the step of providing the cover layer material on the base layer may comprise forming the cover layer material on the base layer; the step of providing the base layer material may comprise forming the base layer from the base layer material on the structural substrate; the cover may be configured to provide the surface effect for the composite structure; the method may comprise injection molding to form the base layer of the cover and the method may comprise spray coating to form the cover layer of the cover; the method may comprise laminating a layer of the cover; the cover layer may comprise a dry film thickness of 3 um to 30 um; the composite structure may comprise a multi-layer material.

The present invention relates to a component for a vehicle interior comprising a composite structure; the composite structure may comprise a substrate; the substrate may comprise a structural substrate; the composite structure may comprise a cover provided on the substrate; the cover provided on the substrate may comprise a base layer and a cover layer; the cover layer may comprise an exterior surface; the cover may be configured to provide a surface effect at the exterior surface may comprise a visual effect and/or a performance effect. The performance effect may comprise stain resistance and/or fluid repellence and/or hardness and/or softness and/or scratch resistance and/or tactile performance and/or antifouling; the surface effect may comprise adhesion evaluation and/or wear resistance and/or stain resistance evaluation and/or water droplet angle and/or feel evaluation and/or texture and/or static friction coefficient and/or dynamic friction coefficient; the visual effect may comprise color and/or texture effect and/or grain effect; the surface effect may be provided by the cover layer; the performance effect may be provided by the cover layer and/or the base layer; the cover layer may comprise a coating; the cover layer may comprise an applied coating; the cover may comprise an intermediate layer; the cover may be formed on the substrate; the cover layer may be formed on the base layer; the cover layer may be formed on the base layer by a coating process; the cover layer may comprise an applied material may comprise a coating; the cover layer may comprise a molded layer and/or an injection molded layer and/or a foam molded layer and/or a skin layer; the base layer may comprise a molded layer; the base layer may comprise a polymer material and/or a molded material and/or an injection-molded material and/or a film and/or a polymer material and/or an elastomer and/or a thermoplastic elastomer and/or TPEE and/or TPU and/or TPV and/or TPE-S; the cover layer may comprise a polymer material and/or a molded material and/or an injection-molded material and/or a film and/or a polyurethane material and/or an acrylic material may comprise silicone and/or a polymer material may comprise fluorine and/or a stain-resistant polymer material; the cover layer may comprise polyacrylate and/or polyurethane and/or aziridine and/or isocyanate and/or carbodiimide and/or polyacrylic acid and/or methyl carboxylic acid methyl cellulose and/or acrylic fluoropolymer and/or organosiloxane polymer; the structural substrate may comprise a panel and/or a base and/or a fiber panel and/or a compressed fiber panel and/or a reduced-density material and/or a stiffness-retaining material and/or a molded substrate and/or a composite panel and/or polymer material and/or a structure; the structural substrate may comprise hemp fiberboard and/or foamed hemp fiberboard and/or foamed glass fiberboard and/or polypropylene and/or polyimide and/or polycarbonate; the cover may comprise a hard segment and a soft segment; the base layer may comprise the hard segments and/or the soft segment; the cover may comprise a polymer material; the polymer material may comprise a thermoplastic elastomeric material; the polymer material may comprise a thermoplastic polyester elastomer; the thermoplastic polyester elastomer may comprise a hard segment and a soft segment; the polymer material may be configured for recyclability as a sub-assembly; the polymer material may be selected from a group of polymer materials may comprise a polyolefin group and/or a thermoplastic elastomeric group and/or an elastomeric group; the cover may comprise a texture provided at the external surface; the cover layer may comprise the texture; the cover may comprise a foam structure; the base layer may comprise the foam structure; the foam structure may comprise a foamed structure; the base layer of the cover may comprise a polymer material; the base layer of the cover may comprise a thermoplastic material; the base layer of the cover may comprise a thermoplastic elastomeric material; the base layer of the cover may comprise a thermoplastic polyester elastomer; the thermoplastic polyester elastomer may comprise a hard segment and a soft segment; the cover layer may comprise a film; the cover layer may comprise a coating; the cover layer may comprise the exterior layer; the cover layer may comprise the applied coating; the cover may comprise a coating system to provide a coating for the cover layer; the coating may comprise a film-forming agent and a crosslinking agent; the coating may comprise a solvent and an anti-fouling agent; the coating may comprise a solvent and a leveling agent; the coating may comprise a solvent and a silane-based auxiliary agent; the coating may comprise water or ethanol or isopropanol or a combination; the coating may comprise polyacrylate or polyurethane or a combination; the coating may comprise aziridine or isocyanate or carbodiimide or a combination; the coating may comprise polyacrylic acid or methyl carboxylic acid methyl cellulose or a combination; the coating may comprise an acrylic fluoropolymer or an organosiloxane polymer or a combination.

The present invention relates to a component for a vehicle interior comprising a composite structure; the composite structure may comprise a substrate; the substrate may comprise a structural substrate; the composite structure may comprise a cover provided on the substrate; the cover provided on the substrate may comprise a base layer and a cover layer; the cover layer may comprise an exterior surface; the cover may be configured to provide a surface effect at the exterior surface may comprise a visual effect and/or a performance effect. The base layer of the cover may comprise a polymer material; the base layer of the cover may comprise a thermoplastic material; the base layer of the cover may comprise a thermoplastic elastomeric material; the base layer of the cover may comprise a thermoplastic polyester elastomer; the thermoplastic polyester elastomer may comprise a hard segment and a soft segment; the cover may comprise the surface effect; the cover may comprise the surface effect at the exterior surface; the surface effect may comprise the visual effect; the surface effect may comprise the performance effect; the surface effect may comprise the visual effect and the performance effect; the visual effect may comprise a decorative effect; the visual effect may comprise a texture effect; the visual effect may comprise a color effect; the visual effect may comprise the decorative effect and the texture effect; the performance effect may comprise stain resistance; the performance effect may comprise abrasion resistance; the performance effect may comprise weather resistance; the performance effect may comprise gloss retention; the performance effect may comprise a friction coefficient; the performance effect may comprise a water droplet angle; the performance effect may comprise adhesion; the performance effect may comprise anti-fouling; the performance effect may comprise scratch resistance; the performance effect may comprise liquid repellence; the performance effect may comprise stain resistance and abrasion resistance; the performance effect may comprise abrasion resistance and gloss retention; the performance effect may comprise a friction coefficient and a water droplet angle; the performance effect may comprise stain resistance and anti-fouling; the performance effect may comprise wear resistance and scratch resistance; the cover layer may comprise the visual effect and the decorative effect; the cover layer may comprise the visual effect and the texture effect; the cover layer may comprise the visual effect and the color effect; the cover layer may comprise the performance effect of liquid repellence; the cover layer may comprise the performance effect of stain resistance; the cover layer may comprise the performance effect of abrasion resistance; the cover layer may comprise the performance effect of anti-fouling; the cover layer may comprise the performance effect and the visual effect; the cover layer may comprise a coating to provide the surface effect at the exterior surface of the cover; the surface effect at the exterior surface of the cover may comprise stain resistance; the surface effect at the exterior surface of the cover may comprise abrasion resistance; the surface effect at the exterior surface of the cover may comprise weather resistance; the surface effect at the exterior surface of the cover may comprise gloss retention; the surface effect at the exterior surface of the cover may comprise a friction coefficient; the surface effect at the exterior surface of the cover may comprise a water droplet angle; the surface effect at the exterior surface of the cover may comprise stain resistance and abrasion resistance; the surface effect at the exterior surface of the cover may comprise abrasion resistance and gloss retention; the surface effect at the exterior surface of the cover may comprise a friction coefficient and a water droplet angle; the surface effect at the exterior surface of the cover may comprise water droplet angle measured by a droplet method; the surface effect at the exterior surface of the cover may comprise shedding of liquid drops under inclination testing; the surface effect at the exterior surface of the cover may comprise a gloss value retained after a Taber wear test conducted with a 500 g load and 500 cycles; the surface effect at the exterior surface of the cover may comprise no visible wear after a Taber wear test conducted with a 500 g load and 500 cycles; the surface effect at the exterior surface of the cover may comprise the peel grade after a room-temperature grid test; the surface effect at the exterior surface of the cover may comprise the peel grade after a humidity grid test; the surface effect at the exterior surface of the cover may comprise the peel grade after a thermal-aging grid test; the surface effect at the exterior surface of the cover may comprise a stick-slip response corresponding to the maximum acceleration; the surface effect at the exterior surface of the cover may comprise a stick-slip response corresponding to the maximum dynamic friction coefficient; the surface effect at the exterior surface of the cover may comprise a stick-slip response corresponding to the maximum static friction coefficient; the surface effect at the exterior surface of the cover may comprise a water droplet angle above 100 degrees at room temperature; the surface effect at the exterior surface of the cover may comprise a water droplet angle of 110 degrees or more at room temperature; the surface effect at the exterior surface of the cover may comprise a gloss change rate of 20 percent or less according to ISO 5470-1-2016.

The present invention relates to a component for a vehicle interior comprising a composite structure; the composite structure may comprise a substrate; the substrate may comprise a structural substrate; the composite structure may comprise a cover provided on the substrate; the cover provided on the substrate may comprise a base layer and a cover layer; the cover layer may comprise an exterior surface; the cover may be configured to provide a surface effect at the exterior surface may comprise a visual effect and/or a performance effect. The base layer may comprise a polyethylene terephthalate fiber material and/or a nonwoven fabric material and/or a mesh fabric and/or foam material and/or sponge material and/or thermoplastic polyester elastomer and/or a foamed material and/or polyethylene terephthalate fiber nonwoven fabric; the cover layer may comprise thermoplastic polyester elastomer and/or thermoplastic vulcanized rubber and/or polyurethane and/or a self-skinned material formed from thermoplastic polyester elastomer; the intermediate layer may comprise polypropylene and/or polyethylene and/or polyethylene terephthalate and/or thermoplastic polyurethane elastomer and/or thermoplastic polyester elastomer the barrier layer may comprise a material configured to limit penetration of material of the cover layer into material of the base layer during formation of the cover; the barrier layer may comprise a material having compatibility with material of the cover layer; and the barrier layer may comprise a laminate with the base layer; the intermediate layer may comprise a resilient material and/or a compressible material and/or a cushioning material and/or a foam material and/or a foam-based material and/or a film; the intermediate layer may comprise polypropylene and/or polyethylene and/or polyethylene terephthalate and/or thermoplastic polyurethane elastomer and/or thermoplastic polyester elastomer; the interface layer may comprise a laminate with the structural substrate; the base layer may comprise a skin layer formed from a thermoplastic polyester elastomer by an injection molding process and the cover layer may comprise a coating on the base layer; the cover may comprise at least one layer; the cover may comprise a multi-layer cover; the cover may comprise a molded cover; the cover may comprise an injection molded layer; the cover may comprise an in-mold injection molded layer; the cover may comprise an in-mold foam injection molded layer; the cover may comprise a foamed structure; the cover may comprise a skin layer; the cover may comprise a molded skin layer; the cover may comprise an injection molded skin layer; the cover may comprise an in-mold injection molded skin layer; the cover may comprise an in-mold foam injection molded skin layer; the cover may comprise a soft foam layer and junction skin layer; the cover may comprise an intermediate layer; the cover may comprise an intermediate layer on each side of the base layer of the cover; the intermediate layer may comprise a self-junction skin layer; the cover may comprise a thermoplastic elastomeric material; the cover may comprise a thermoplastic polyester elastomer; the cover may comprise TPEE; the cover may comprise a film-forming agent and a crosslinking agent; the cover may comprise a solvent and an anti-fouling agent; the cover may comprise a solvent and a leveling agent; the cover may comprise a solvent and a silane-based auxiliary agent; the cover may comprise water or ethanol or isopropanol or a combination; the cover may comprise polyacrylate or polyurethane or a combination; the cover may comprise aziridine or isocyanate or carbodiimide or a combination; the cover may comprise an acrylic fluoropolymer or an organosiloxane polymer or a combination; the cover may comprise a polymer material may comprise thermoplastic polyester elastomer; the cover may comprise a polymer material may comprise thermoplastic polyester elastomer may comprise a chain segment; the chain segment of the thermoplastic polyester elastomer may comprise an active functional group; the active functional group may comprise a hydroxyl group, a carboxyl group, an amine group, or a combination; the thermoplastic polyester elastomer may comprise a hard segment and a soft segment; the hard segment of the thermoplastic polyester elastomer may comprise: poly (butylene terephthalate), poly(ethylene terephthalate), poly (trimethylene terephthalate), poly (trimethylene terephthalate)/poly (butylene terephthalate), poly(2,6-naphthalate), poly (trimethylene terephthalate), poly(ethylene terephthalate)/polybutylene terephthalate copolymers, poly (dimethyl terephthalate/m-xylylene)/1,4-butanediol copolymers, poly (2,5-furan dicarboxylate), poly(2,5-furandicarboxylic acid) propylene glycol ester, poly (2,5-furandicarboxylate), poly(2,5-furan dicarboxylate), or a combination; As indicated schematically, the method may comprise: polybutylene terephthalate, poly(2,5-furandicarboxylate), or a combination; the soft segment of the thermoplastic polyester elastomer may comprise: polyethylene glycol, polybutylene glycol, polycaprolactone, polyethylene glycol, fatty acid dimer diol, polytetramethylene ether, ethylene oxide-propylene oxide copolymer bisphenol A ether, polypropylene glycol, polylactide, polyglycolide, or a combination; polyethylene glycol, polycaprolactone, polytetramethylene ether, or a combination; the cover may comprise a thermoplastic polyester elastomer may comprise an active functional group; the cover may comprise a crosslinking agent selected to react with the active functional group; the cover may comprise the active functional group and the cover may comprise the crosslinking agent selected to react with the active functional group; the cover may comprise a film-forming agent in an amount of 30-45 wt percent; the cover may comprise a crosslinking agent in an amount of 3-15 wt percent; the cover may comprise a thickness of 1.5-2.5 mm and the applied coating may comprise an elongation at break of 100-200 percent; the cover may comprise a thickness of 1.2-1.5 mm and the applied coating may comprise an elongation at break of 200-300 percent; the cover may comprise a thickness of 0.3-1.2 mm and the applied coating may comprise an elongation at break of 300-500 percent; the cover may comprise a thickness of 0.3-2.5 mm; the cover may comprise a resin and a plasticizer; the cover may comprise a melt index of 50-400 g/10 min measured at 220 degrees C. and 2.16 kg; the cover may comprise a density of 0.95-1.15 g/cc; the cover may comprise a texture replicated during injection molding; the cover may comprise a spray-coated applied coating.

The present invention relates to a component for a vehicle interior comprising a composite structure; the composite structure may comprise a substrate; the substrate may comprise a structural substrate; the composite structure may comprise a cover provided on the substrate; the cover provided on the substrate may comprise a base layer and a cover layer; the cover layer may comprise an exterior surface; the cover may be configured to provide a surface effect at the exterior surface may comprise a visual effect and/or a performance effect. The base layer of the cover may comprise a skin layer; the base layer of the cover may comprise a texture; the base layer of the cover may comprise a foamed structure; the base layer of the cover may comprise a polymer material; the base layer of the cover may comprise a thermoplastic material; the base layer of the cover may comprise a thermoplastic elastomeric material; the base layer of the cover may comprise a thermoplastic polyester elastomer; the base layer of the cover may comprise TPEE; the base layer of the cover may comprise a layer; the base layer of the cover may comprise a molded layer; the base layer of the cover may comprise an injection molded layer; the base layer of the cover may comprise an in-mold injection molded layer; the base layer of the cover may comprise an in-mold foam injection molded layer; the base layer of the cover may comprise a film-forming agent and a crosslinking agent; the base layer of the cover may comprise a solvent and an anti-fouling agent; the base layer of the cover may comprise a solvent and a leveling agent; the base layer of the cover may comprise a solvent and a silane-based auxiliary agent; the base layer of the cover may comprise water or ethanol or isopropanol or a combination; the base layer of the cover may comprise polyacrylate or polyurethane or a combination; the base layer of the cover may comprise a texture; the base layer of the cover may comprise a foamed structure; the base layer of the cover may comprise a soft foam layer and junction skin layers; the base layer of the cover may comprise a thickness of 0.3 mm to 2.5 mm; the base layer of the cover may comprise a resin and a plasticizer; the base layer of the cover may comprise an additional resin or a plasticizer or a combination; the base layer of the cover may comprise a melt index of 50 g/10 min to 400 g/10 min measured at 220 degrees C. and 2.16 kg; the base layer of the cover may comprise a density of 0.95 g/cm\hat{ }3 to 1.15 g/cm\hat{ }3; the base layer of the cover may comprise a tensile strength of 3 MPa to 10 MPa; the base layer of the cover may comprise an elongation at break of 100 percent to 800 percent; the base layer of the cover may comprise a tear strength of 20 kN/m to 60 kN/m; the base layer of the cover may comprise a texture replicated during injection molding; the base layer of the cover may comprise a thermoplastic polyester elastomer formed by an injection molding process and the cover layer of the cover may comprise a coating; the base layer of the cover may comprise a soft foam layer.

The present invention relates to a component for a vehicle interior comprising a composite structure; the composite structure may comprise a substrate; the substrate may comprise a structural substrate; the composite structure may comprise a cover provided on the substrate; the cover provided on the substrate may comprise a base layer and a cover layer; the cover layer may comprise an exterior surface; the cover may be configured to provide a surface effect at the exterior surface may comprise a visual effect and/or a performance effect. The cover layer may comprise a cover layer material; the cover layer material may comprise a film and/or an applied film and/or a coating and/or an applied coating and/or a formed layer; the cover layer material may comprise: a compatible resin and/or a plasticizer or a combination; the compatible resin may comprise: polybutylene terephthalate and/or polyethylene terephthalate and/or polyamide and/or acrylonitrile-butadiene-styrene copolymer and/or polycarbonate and/or epoxy resin or a combination; the plasticizer may comprise an ortho-benzoate compound and/or a phthalic acid compound and/or an aliphatic dibasic acid compound and/or an epoxy ester compound and/or a phosphate ester compound or a combination; the cover layer material may comprise a melt index of 50-400 g/10 min and/or 200-300 g/10 min, measured at 220 degrees C. and 2.16 kg; the density of the cover layer material may be 0.95-1.15 g/cm and/or 1.05-1.15 g/cm; the cover layer of the cover may comprise a coating system may comprise a coating; the coating of the coating system may comprise a solid content of 10-30 wt percent; the coating of the coating system may comprise an applied coating; the applied coating may comprise a thickness of 5-18 um; the applied coating may comprise a density of 0.7-1.3 g/cc; the coating may comprise a thickness of 5 to 18 μm and/or the density of the coating may be 0.7-1.3 g/cm and/or 0.9-1.1 g/cm; the coating may be formed by a spray coating process; the cover layer may comprise a texture formed at the coating; the coating may be formed from a coating system; the coating system may comprise: a film-forming agent and a crosslinking agent; the film-forming agent may comprise: polyacrylate and/or polyurethane or a combination; the crosslinking agent may comprise aziridine and/or isocyanate and/or carbodiimide or a combination; the coating system further may comprise: a solvent and/or a feel agent and/or a leveling agent and/or an anti-fouling agent or a combination; the solvent may comprise water and/or ethanol and/or isopropanol or a combination; the hand-feel agent may comprise a silane-based auxiliary agent; the leveling agent may comprise: polyacrylic acid and/or methyl carboxylic acid methyl cellulose or a combination; the anti-fouling agent may comprise an acrylic fluoropolymer and/or an organosiloxane polymer or a combination; thickness of the cover may be 1.5-2.5 mm and elongation at break of the coating may be 100-200 percent; thickness of the cover may be 1.2-1.5 mm and elongation at break of the coating may be 200-300 percent; thickness of the cover may be 0.3-1.2 mm and elongation at break of the coating may be 300-500 percent.

The present invention relates to a component for a vehicle interior comprising a composite structure; the composite structure may comprise a substrate; the substrate may comprise a structural substrate; the composite structure may comprise a cover provided on the substrate; the cover provided on the substrate may comprise a base layer and a cover layer; the cover layer may comprise an exterior surface; the cover may be configured to provide a surface effect at the exterior surface may comprise a visual effect and/or a performance effect. The component may comprise a vehicle interior component; the component may comprise an instrument panel and/or a trim panel and/or a door panel component and/or a console and/or a floor console and/or a center console and/or an overhead console and/or an armrest and/or a seat assembly; the vehicle may comprise an automobile and/or a work vehicle and/or a passenger vehicle and/or an aircraft and/or a vessel and/or a ship and/or a cycle and/or an electric vehicle and/or a rail vehicle and/or a train and/or a subway car and/or a light rail section and/or a car.

The present invention relates to a component for a vehicle interior comprising a composite structure; the composite structure may comprise a substrate; the substrate may comprise a structural substrate; the composite structure may comprise a cover provided on the substrate; the cover provided on the substrate may comprise a base layer and a cover layer; the cover layer may comprise an exterior surface; the cover may be configured to provide a surface effect at the exterior surface may comprise a visual effect and/or a performance effect. The component may be produced by a method comprising the steps of providing a base layer material for the base layer of the cover, providing the cover layer material for the cover layer on the base layer and providing the cover on the structural substrate; the step of providing the cover layer material on the base layer may comprise forming the cover layer material on the base layer; the step of providing the base layer material may comprise forming the base layer from the base layer material on the structural substrate; the cover may be configured to provide the surface effect for the composite structure; the method may comprise molding to form the base layer of the cover; the method may comprise injection molding to form the base layer of the cover; the method may comprise forming a texture in the base layer of the cover; the method may comprise forming a texture in the cover layer of the cover; the method may comprise foaming to form the base layer of the cover; the method may comprise forming the soft foam layer and the junction skin layers in the base layer of the cover; the method may comprise spray coating to form the cover; the method may comprise curing the applied coating; the method may comprise forming the cover layer directly on the base layer of the cover; the method may comprise providing the intermediate layer on the base layer of the cover and forming the cover layer on the intermediate layer; the base layer of the cover may comprise a thermoplastic elastomeric material; the base layer of the cover may comprise a thermoplastic polyester elastomer; the cover may comprise a film-forming agent and a crosslinking agent; the cover may comprise a solvent and an anti-fouling agent; the base layer of the cover may comprise a thermoplastic polyester elastomer may comprise an active functional group; the base layer of the cover may comprise the active functional group and the cover may comprise a crosslinking agent selected to react with the active functional group; the method may comprise in-mold injection molding to form the base layer of the cover; the method may comprise in-mold foam injection molding to form the base layer of the cover; the method may comprise forming the cover by a coating process on the base layer of the cover; the method may comprise spray coating to form the cover; the method may comprise curing the applied coating; the method may comprise forming the cover layer on the base layer of the cover; the method may comprise providing the intermediate layer on the base layer of the cover and forming the cover layer on the intermediate layer; the method may comprise forming the cover layer as a film on the base layer of the cover; the method may comprise forming the cover layer as a coating on the base layer of the cover; the method may comprise forming the applied coating on the base layer of the cover; the method may comprise forming the cover layer to provide the surface effect at the exterior surface of the cover; the method may comprise forming the cover layer to provide the surface effect at the exterior surface of the cover; the method may comprise combining the intermediate layer with the base layer of the cover; the method may comprise combining the cover layer with the intermediate layer; the method may comprise laminating a layer of the cover; the method may comprise assembling the structural substrate into the component; the surface effect at the exterior surface of the cover may comprise the maximum dynamic friction coefficient and the maximum static friction coefficient; the cover layer may comprise a dry film thickness of 3 um to 30 um; the cover layer may comprise a dry film thickness of 8 um to 15 um; the cover layer may comprise a Shore A hardness of 40 to 80; the base layer of the cover may comprise a thickness of 1.5 mm to 3 mm; the base layer of the cover may comprise a flexural modulus of at least 1800 MPa; the base layer of the cover may comprise a density of less than 0.85 g/cc; the base layer of the cover may comprise hemp fiberboard or foamed hemp fiberboard or foamed glass fiberboard or polypropylene or polyimide or polycarbonate or a combination; the intermediate layer may comprise polypropylene or polyethylene or polyethylene terephthalate or thermoplastic polyurethane elastomer or thermoplastic polyester elastomer or a combination; the cover layer may comprise thermoplastic polyester elastomer or thermoplastic vulcanized rubber or polyurethane or a combination; the cover layer may comprise a self-skinned surface formed after foaming; the cover may comprise a composite form may comprise at least two layers; the composite structure may comprise a multi-layer material.

The present invention relates to a component for a vehicle interior comprising a composite structure may comprise a cover; the cover may comprise a base layer and a cover layer; the cover layer may comprise an exterior surface; the cover may be configured to provide a surface effect; the surface effect may comprise a visual effect and/or a performance effect; the cover may comprise a performance effect; the performance effect may comprise stain resistance and/or fluid repellence and/or hardness and/or scratch resistance and/or tactile performance; the component may further comprise a substrate; the substrate may comprise a structural substrate; the cover may be provided on the substrate. The surface effect may comprise adhesion evaluation and/or wear resistance and/or stain resistance evaluation and/or water droplet angle and/or feel evaluation and/or friction coefficient.

The present invention relates to a composite structure for a component for an interior of a vehicle; the composite structure may comprise a cover; the cover may comprise a base layer and a cover layer; the base layer may comprise a skin layer formed from a thermoplastic polyester elastomer by an injection molding process; the cover layer may comprise a coating on a surface of the base layer of the cover; the composite structure may further comprise a substrate configured to provide a structural substrate for the cover; the cover may be formed on the substrate; the cover may be molded on the substrate; the cover may comprise a skin material; the base layer of the cover may comprise a soft foam layer; the cover may comprise a self-junction skin layer located on two sides of the soft foam layer; the cover may comprise a polymer material; the polymer material may comprise a thermoplastic polyester elastomer; a chain segment of the thermoplastic polyester elastomer may comprise an active functional group preferably the active functional group may comprise a hydroxyl group and/or a carboxyl group and/or an amine group or a combination; the thermoplastic polyester elastomer may comprise a hard segment and a soft segment; the hard segment of the thermoplastic polyester elastomer may comprise: poly (butylene terephthalate) and/or poly(ethylene terephthalate) and/or poly (trimethylene terephthalate) and/or poly (trimethylene terephthalate)/poly (butylene terephthalate) and/or poly(2,6-naphthalate) and/or poly (trimethylene terephthalate) and/or poly (ethylene terephthalate)/polybutylene terephthalate copolymers and/or poly (dimethyl terephthalate/m-xylylene)/1,4-butanediol copolymers and/or poly(2,5-furan dicarboxylate) and/or poly(2,5-furandicarboxylic acid) propylene glycol ester and/or poly(2,5-furandicarboxylate) and/or poly(2,5-furan dicarboxylate) or a combination; preferably, the method may comprise: polybutylene terephthalate and/or poly(2,5-furandicarboxylate) or a combination; the soft segment of the thermoplastic polyester elastomer may comprise: polyethylene glycol and/or polybutylene glycol and/or polycaprolactone and/or polyethylene glycol and/or fatty acid dimer diol and/or polytetramethylene ether and/or ethylene oxide-propylene oxide copolymer bisphenol A ether and/or polypropylene glycol and/or polylactide and/or polyglycolide or a combination; polyethylene glycol and/or polycaprolactone and/or polytetramethylene ether and/or or a combination; the material for forming the cover layer of the cover further may comprise: a compatible resin and/or a plasticizer or a combination; the compatible resin may comprise: polybutylene terephthalate and/or polyethylene terephthalate and/or polyamide and/or acrylonitrile-butadiene-styrene copolymer and/or polycarbonate and/or epoxy resin or a combination; the plasticizer may comprise: an ortho-benzoate compound and/or a phthalic acid compound and/or an aliphatic dibasic acid compound and/or an epoxy ester compound and/or a phosphate ester compound or a combination; the material for forming the cover layer of the cover may comprise a melt index of 50-400 g/10 min and/or 200-300 g/10 min, measured at 220 degrees C. and 2.16 kg; and/or the density of the material forming the cover layer of the cover may be 0.95-1.15 g/cm and/or 1.05-1.15 g/cm; the polymer material configured for recyclability as a sub-assembly may be selected from a group of polymer materials and may comprise a polyolefin group and/or a thermoplastic elastomeric group and/or an elastomeric group; the coating may be formed from a coating system; the coating system may comprise a film-forming agent and a crosslinking agent; the film-forming agent may comprise polyacrylate and/or, polyurethane or a combination; the crosslinking agent may comprise aziridine and/or isocyanate and/or carbodiimide or a combination; the coating system further may comprise a solvent and/or a feel agent and/or a leveling agent and/or an anti-fouling agent or a combination; the solvent may comprise water and/or ethanol and/or isopropanol or a combination; the hand-feel agent may comprise a silane-based auxiliary agent; the leveling agent may comprise polyacrylic acid and/or methyl carboxylic acid methyl cellulose or a combination; the anti-fouling agent may comprise an acrylic fluoropolymer and/or an organosiloxane polymer or a combination; the coating may be formed by a spray coating process; the cover may comprise a texture; the cover may comprise aziridine and/or isocyanate and/or carbodiimide or a combination; the cover may comprise polyacrylic acid or methyl carboxylic acid methyl cellulose or a combination; the cover may comprise an acrylic fluoropolymer or an organosiloxane polymer or a combination; the cover may comprise a solid content of 10 wt percent to 30 wt percent; the cover layer may comprise a thickness of 5 um to 18 um; the cover layer may comprise a density of 0.7 g/cc to 1.3 g/cc; the cover may comprise a film-forming agent in an amount of 30 wt percent to 45 wt percent; the cover may comprise a crosslinking agent in an amount of 3 wt percent to 15 wt percent; the base layer of the cover may comprise a thickness of 1.5 mm to 2.5 mm and the cover layer may comprise an elongation at break of 100 percent to 200 percent; the base layer of the cover may comprise a thickness of 1.2 mm to 1.5 mm and the cover layer may comprise an elongation at break of 200 percent to 300 percent; the base layer of the cover may comprise a thickness of 0.3 mm to 1.2 mm and the cover layer may comprise an elongation at break of 300 percent to 500 percent; the surface effect at the exterior surface of the cover may comprise a water droplet angle above 100 deg C. at room temperature; the surface effect at the exterior surface of the cover may comprise a water droplet angle of 110 deg C. or more at room temperature; the surface effect at the exterior surface of the cover may comprise a gloss change rate of 20 percent or less according to ISO 5470-1-2016; the surface effect at the exterior surface of the cover may comprise a peel grade of Grade 1 or Grade 0 according to ISO 2409:1992; the surface effect at the exterior surface of the cover may comprise a maximum acceleration of 0.05 to 1.50 according to VDA 230-206; the surface effect at the exterior surface of the cover may comprise a maximum dynamic friction coefficient of 0.2 to 1.2 according to VDA 230-206; the surface effect at the exterior surface of the cover may comprise a maximum static friction coefficient of 0.2 to 1.50 according to VDA 230-206; the surface effect at the exterior surface of the cover may comprise water droplet angle and gloss change rate; the surface effect at the exterior surface of the cover may comprise peel grade maximum acceleration; the performance effect of the cover may comprise a water droplet angle of the cover at room temperature may be above 100 degrees C. and/or 110 degrees C. or more; the cover may comprise a gloss change rate of 20 percent or less and/or 15 percent or less according to ISO 5470-1-2016; the peel grade of the cover according to ISO 2409:1992 may be Grade 1 or Grade 0; the maximum acceleration measured by the cover according to the standard VDA 230-206; stick-slip test standard may be 0.05-1.50; preferably 0.08-1.00; the maximum dynamic friction coefficient measured by the cover according to the standard VDA 230-206; stick-slip test standard may be 0.2-1.2 and/or 0.3-1.0; the maximum static friction coefficient measured by the cover according to the standard VDA 230-206; stick-slip test standard may be 0.2-1.50 and/or 0.3-1.2.

### FIGURES

FIG. 1A is a schematic perspective view of a vehicle according to an exemplary embodiment.

FIG. 1B is a schematic perspective view of a vehicle interior according to an exemplary embodiment.

FIG. 2 is a schematic side elevation view of a vehicle interior according to an exemplary embodiment.

FIG. 3 is a schematic perspective view of a component for a vehicle interior according to an exemplary embodiment.

FIG. 4 is a schematic side elevation view of a component for a vehicle interior according to an exemplary embodiment.

FIG. 5 is a schematic side elevation view of a component for a vehicle interior according to an exemplary embodiment.

FIG. 6 is a schematic side elevation view of a component for a vehicle interior according to an exemplary embodiment

FIGS. 7A and 7B are schematic side elevation views of a component for a vehicle interior according to an exemplary embodiment

FIG. 8 is a schematic side elevation view of a component for a vehicle interior according to an exemplary embodiment

FIG. 9 is a schematic side elevation view of a component for a vehicle interior according to an exemplary embodiment.

FIG. 10 is a schematic side elevation view of a component for a vehicle interior according to an exemplary embodiment.

FIG. 11 is a schematic side elevation view of a component for a vehicle interior according to an exemplary embodiment.

FIG. 12 is a schematic side elevation view of a component for a vehicle interior according to an exemplary embodiment.

FIG. 13A is a schematic perspective view of a composite structure for a component for a vehicle interior according to an exemplary embodiment.

FIG. 13B is a schematic perspective exploded view of a composite structure for a component for a vehicle interior according to an exemplary embodiment.

FIG. 13C is a schematic side elevation view of a composite structure for a component for a vehicle interior according to an exemplary embodiment.

FIG. 13D is a schematic side elevation view of a composite structure for a component for a vehicle interior according to an exemplary embodiment.

FIG. 14A is a schematic side elevation view of a composite structure for a component for a vehicle interior according to an exemplary embodiment.

FIG. 14B is a schematic side elevation exploded view of a composite structure for a component for a vehicle interior according to an exemplary embodiment.

FIG. 14C is a schematic perspective view of a composite structure for a component for a vehicle interior according to an exemplary embodiment.

FIG. 14D is a schematic perspective exploded view of a composite structure for a component for a vehicle interior according to an exemplary embodiment.

FIG. 15A is a schematic side elevation view of a composite structure for a component for a vehicle interior according to an exemplary embodiment.

FIG. 15B is a schematic side elevation exploded view of a composite structure for a component for a vehicle interior according to an exemplary embodiment.

FIG. 15C is a schematic perspective view of a composite structure for a component for a vehicle interior according to an exemplary embodiment.

FIG. 15D is a schematic perspective exploded view of a composite structure for a component for a vehicle interior according to an exemplary embodiment.

FIG. 16A is a schematic perspective view of a composite structure for a component for a vehicle interior according to an exemplary embodiment.

FIG. 16B is a schematic side elevation view of a composite structure for a component for a vehicle interior according to an exemplary embodiment.

FIG. 17A is a schematic perspective view of a composite structure for a component for a vehicle interior according to an exemplary embodiment.

FIG. 17B is a schematic side elevation view of a composite structure for a component for a vehicle interior according to an exemplary embodiment.

FIG. 18A is a schematic perspective view of a composite structure for a component for a vehicle interior according to an exemplary embodiment.

FIG. 18B is a schematic side elevation view of a composite structure for a component for a vehicle interior according to an exemplary embodiment.

FIG. 18C is a schematic perspective view of a composite structure for a component for a vehicle interior according to an exemplary embodiment.

FIG. 18D is a schematic perspective view of a composite structure for a component for a vehicle interior according to an exemplary embodiment.

FIG. 18E is a schematic side elevation view of a composite structure for a component for a vehicle interior according to an exemplary embodiment.

FIGS. 19A through 19C are schematic perspective views of a method for producing a composite structure for a component for a vehicle interior according to an exemplary embodiment.

FIG. 20 is a schematic perspective view of a composite structure for a component for a vehicle interior according to an exemplary embodiment.

FIGS. 21A and 21B are schematic perspective views of a composite structure for a component for a vehicle interior according to an exemplary embodiment.

FIGS. 22A and 22B are schematic perspective views of a method of producing a composite structure for a component for a vehicle interior according to an exemplary embodiment.

FIGS. 22C and 22D are schematic perspective views of a composite structure for a component for a vehicle interior according to an exemplary embodiment.

FIGS. 23A and 23B are schematic perspective views of a method of producing a composite structure for a component for a vehicle interior according to an exemplary embodiment.

FIG. 24A is a schematic perspective view of a composite structure for a component for a vehicle interior according to an exemplary embodiment.

FIG. 24B is a schematic perspective detail view of a composite structure for a component for a vehicle interior according to an exemplary embodiment.

FIG. 25A is a schematic perspective view of a composite structure for a component for a vehicle interior according to an exemplary embodiment.

FIG. 25B is a schematic perspective detail view of a composite structure for a component for a vehicle interior according to an exemplary embodiment.

FIG. 25C is a schematic perspective view of a composite structure for a component for a vehicle interior according to an exemplary embodiment.

FIG. 25D is a schematic perspective detail view of a composite structure for a component for a vehicle interior according to an exemplary embodiment.

FIG. 25E is a schematic side elevation detail view of a composite structure for a component for a vehicle interior according to an exemplary embodiment.

FIG. 25F is a schematic side elevation detail view of a composite structure for a component for a vehicle interior according to an exemplary embodiment.

FIGS. 26A and 26B are schematic perspective detail diagrams of a composite structure for a component for a vehicle interior according to an exemplary embodiment.

FIGS. 27A and 27B are schematic perspective detail diagrams of a composite structure for a component for a vehicle interior according to an exemplary embodiment.

FIG. 28A is a schematic perspective view of a composite structure for a component for a vehicle interior according to an exemplary embodiment.

FIGS. 28B and 28C are schematic perspective views of a composite structure for a component for a vehicle interior according to an exemplary embodiment.

FIGS. 29A and 29B are schematic diagrams of a surface effect of a composite structure of a component for a vehicle interior according to an exemplary embodiment.

FIGS. 30A and 30B are schematic diagrams of a surface effect of a composite structure of a component for a vehicle interior according to an exemplary embodiment.

FIGS. 31A through 31D are schematic diagrams of a surface effect of a composite structure of a component for a vehicle interior according to an exemplary embodiment.

FIG. 32 is a schematic diagram of a surface effect of a composite structure of a component for a vehicle interior according to an exemplary embodiment.

FIG. 33 is a schematic diagram of a surface effect of a composite structure of a component for a vehicle interior according to an exemplary embodiment.

FIG. 34 is a schematic diagram of an apparatus for testing surface effect of a composite structure for a vehicle interior according to an exemplary embodiment.

FIGS. 35A and 35B are schematic diagrams of a surface effect of a composite structure for a vehicle interior according to an exemplary embodiment.

FIGS. 36A and 36B are schematic diagrams of a surface effect of a composite structure for a vehicle interior according to an exemplary embodiment.

FIGS. 37A and 37B are schematic diagrams of a surface effect of a composite structure for a vehicle interior according to an exemplary embodiment.

FIGS. 38A and 38B are schematic diagrams of a surface effect of a composite structure for a vehicle interior according to an exemplary embodiment.

### DESCRIPTION

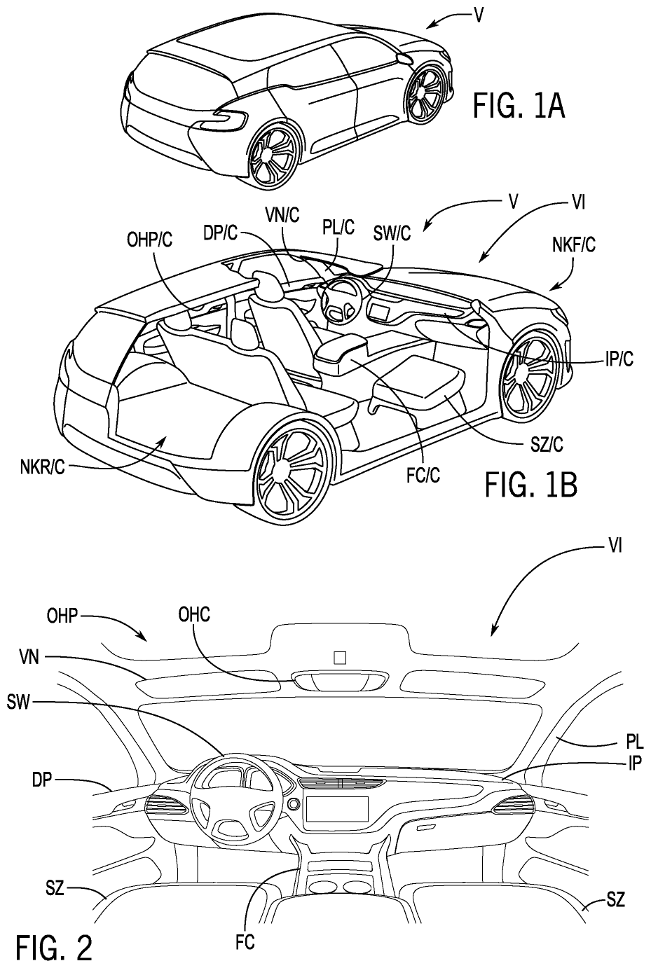

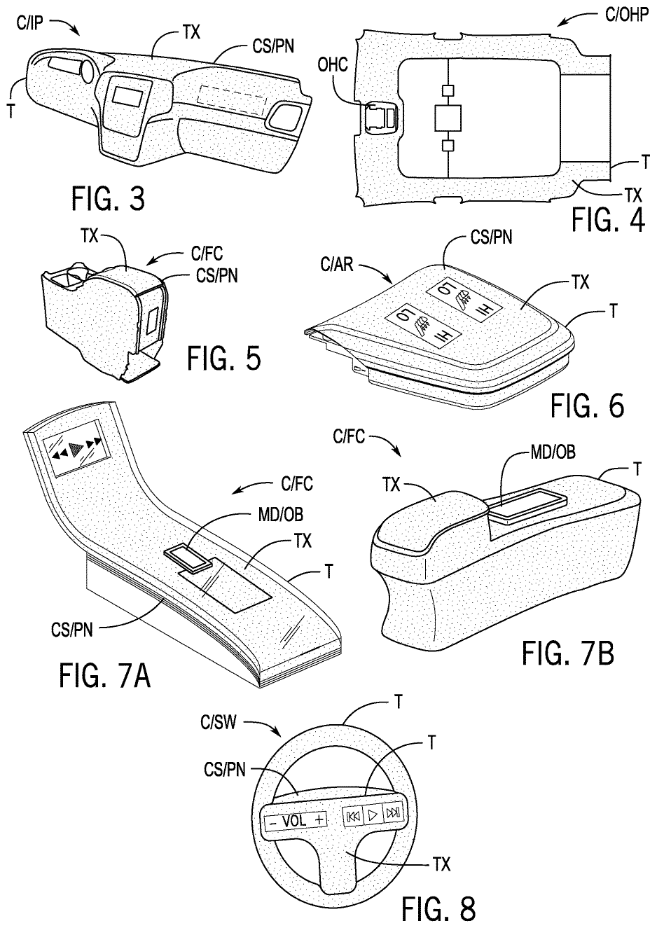

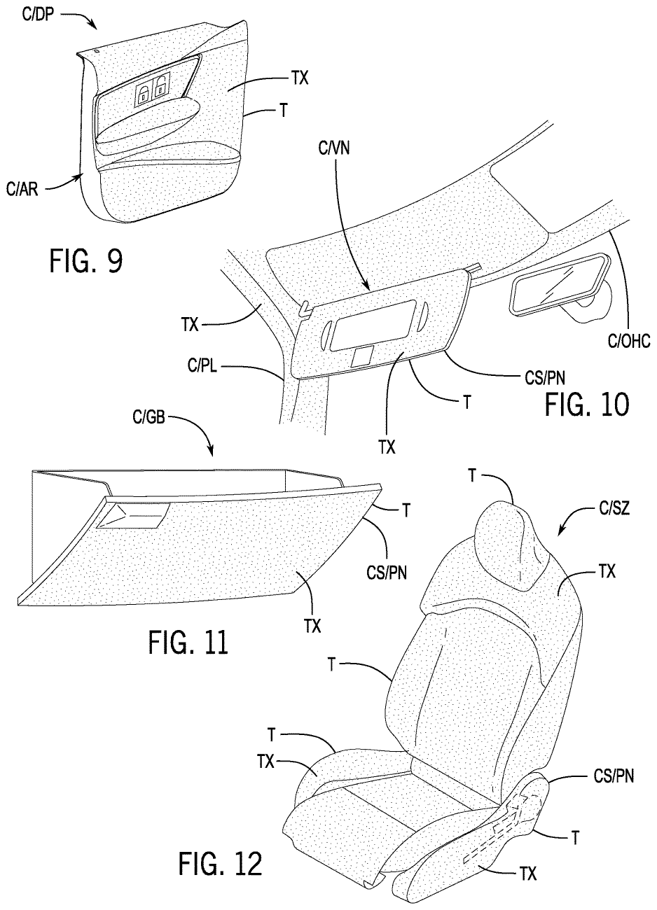

Referring to FIGS. 1A and 2A, a vehicle V with a vehicle interior VI comprising components C is shown according to an exemplary embodiment. As indicated schematically according to an exemplary embodiment in FIGS. 1B, 2, 3, 4, 5, 6, 7A-7B, 8, 9, 10, 11 and 12, components C for the vehicle interior may comprise an instrument panel IP, overhead system/console OHS/OHC, console such as floor console FC, door panel DP, pillar PL, vanity VN, storage compartment GB, seat assembly SZ, etc. As indicated in FIGS. 3, 4, 5, 6, 7A-7B, 8, 9, 10, 11, 12, and 13A-13D, component C may comprise a composite structure CS comprising a substrate/base shown as structural substrate SB and a cover comprising a base layer T and a cover layer TX configured to provide an exterior surface. See also FIGS. 1B and 2.

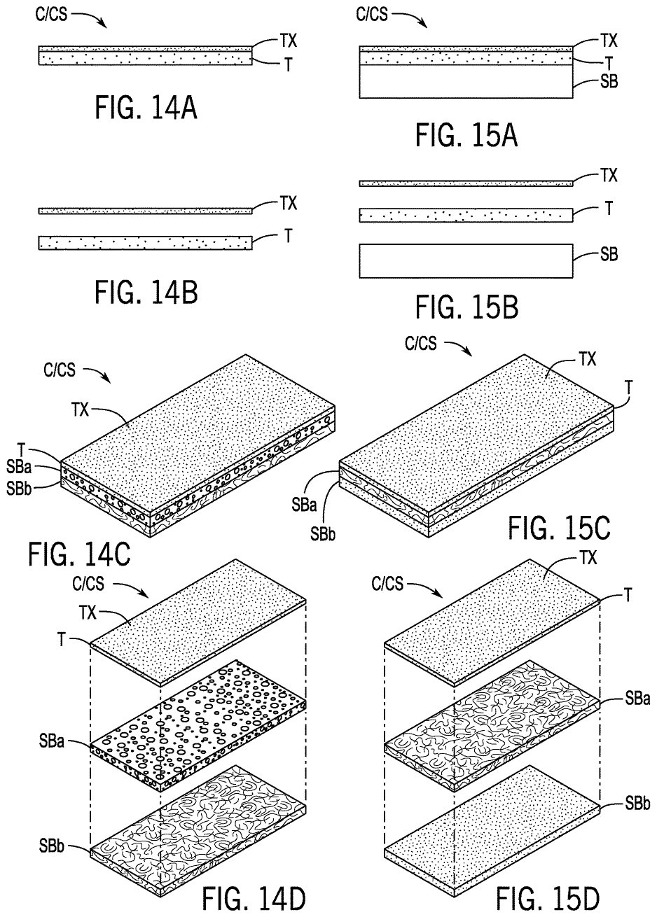

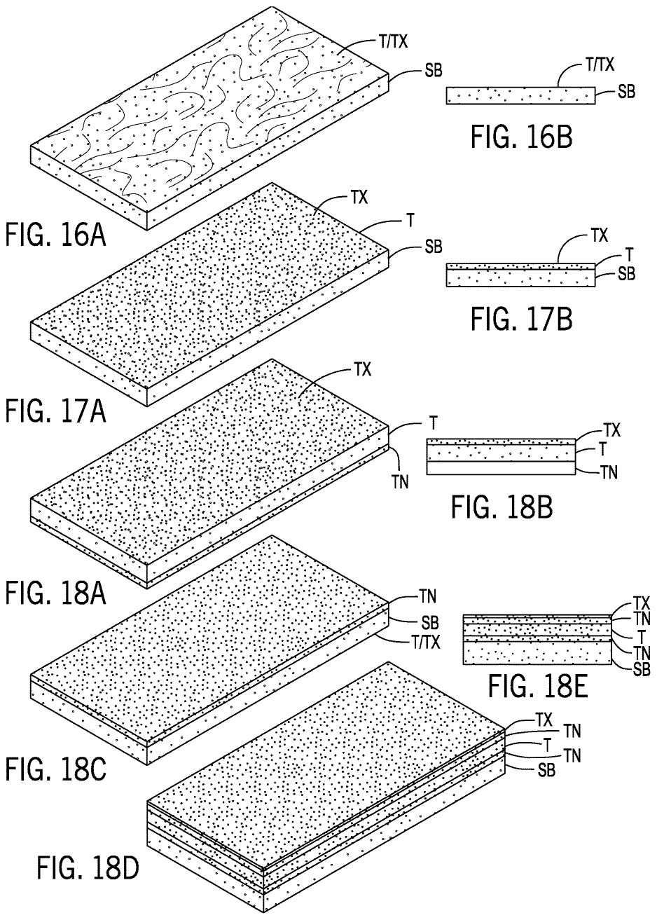

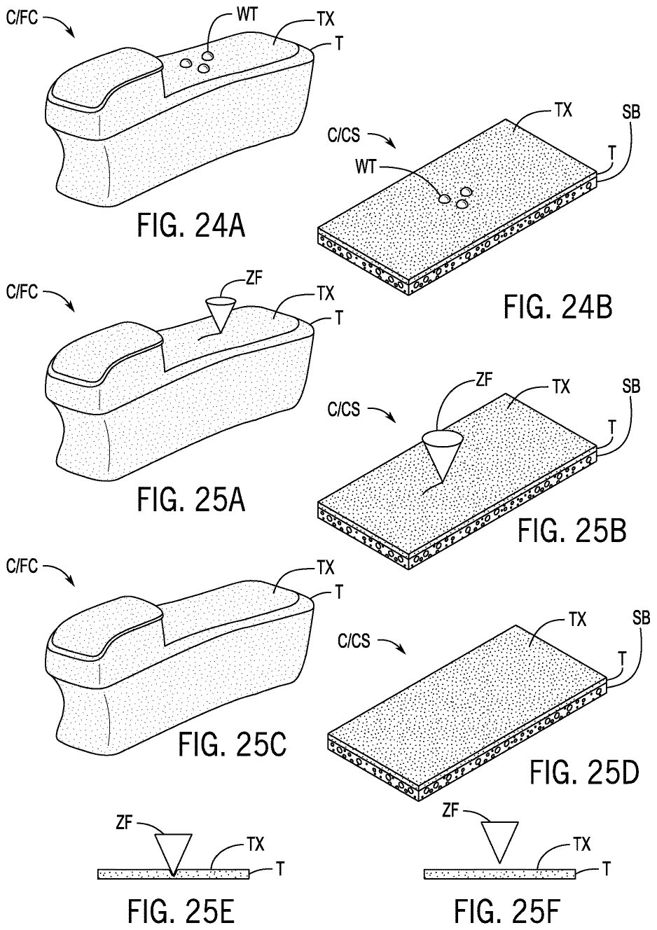

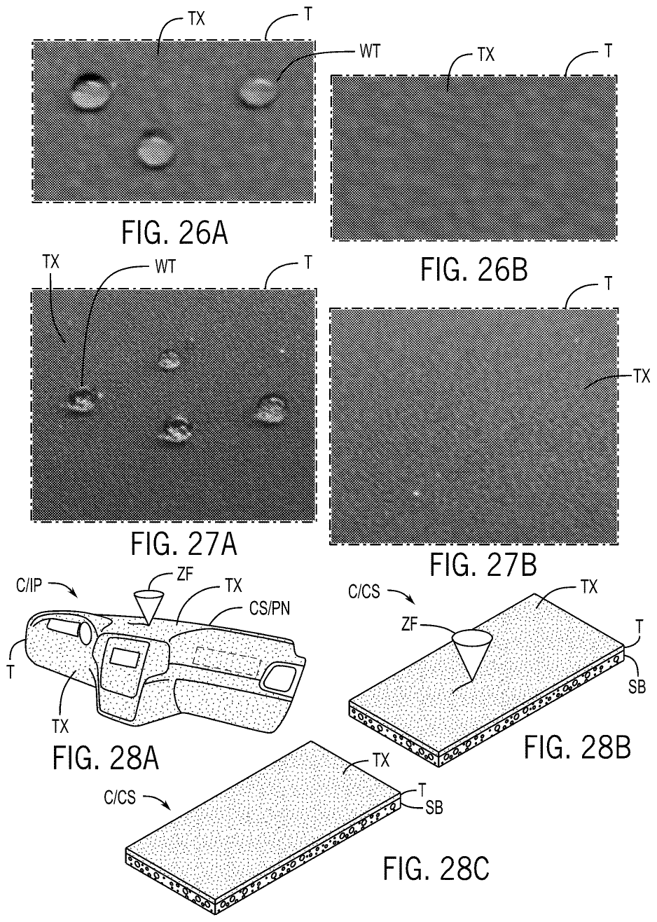

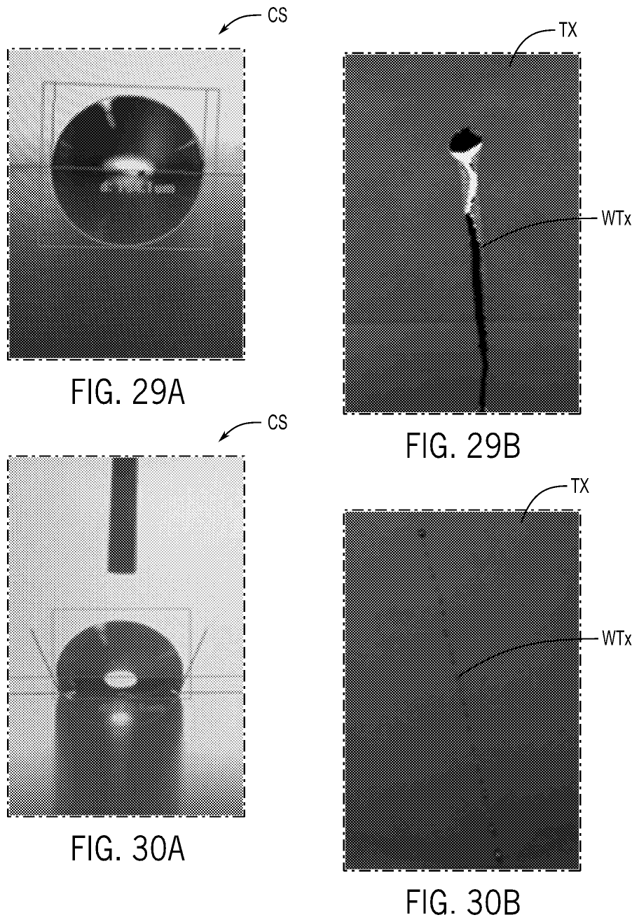

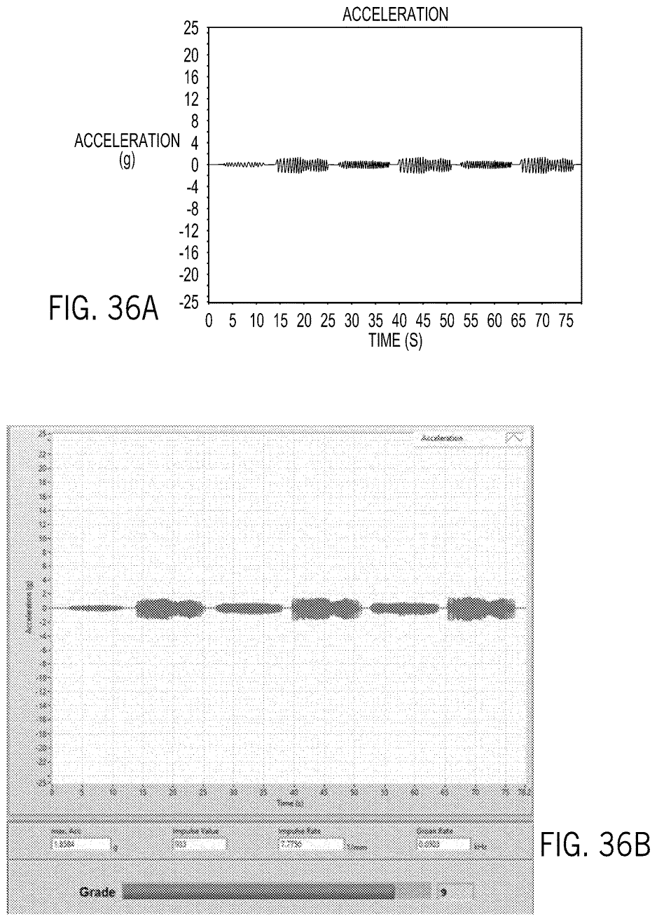

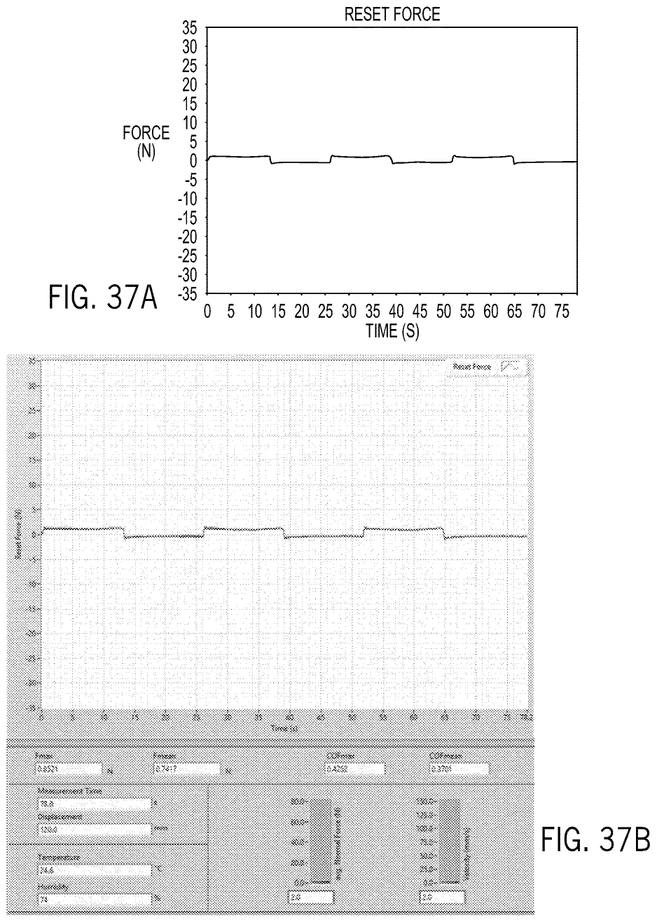

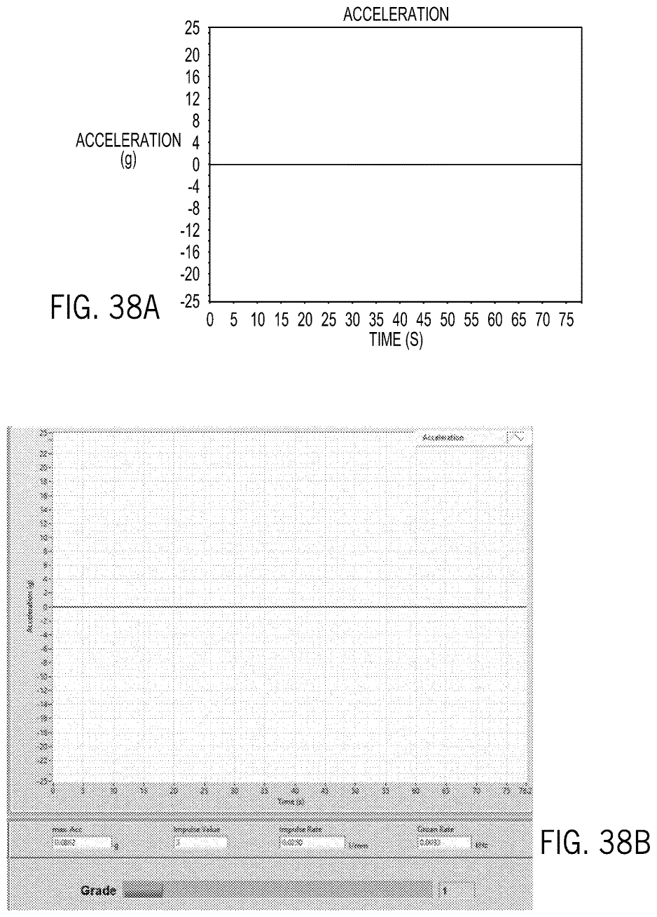

As indicated schematically in FIGS. 3, 4, 5, 6, 7A-7B, 8, 9, 10, 11, 12, 24A-24B, 25A-25F, 26A-26B, 27A-27B and 28A-28C, the composite structure CS with substrate SB and cover comprising base layer T and cover layer TX may be configured/formed to provide a surface effect such as visual effect and/or performance effect. See also FIGS. 3, 4, 5, 6, 7A-7B, 8, 9, 10, 11, 12, 13A-13D, 14A-14D, 15A-15D, 16A-16B, 17A-17B, 18A-18E and 20. As indicated schematically in FIGS. 24A-24B, 25A-25F, 26A-26B, 27A-27B and 28A-28C, the composite structure CS with cover comprising base layer T and cover layer TX may provide a surface effect providing a visual effect such as a decorative effect, texture effect, color effect, etc. and/or a performance effect such as durability/wear resistance, scratch resistance, stain resistance, liquid repellence, anti-fouling, touch-feel/tactile performance, hardness/softness, friction coefficient, adhesion, etc. See also FIGS. 1B, 2, 3, 4, 5, 6, 7A-7B, 8, 9, 10, 11 and 12. As indicated schematically in FIGS. 24A-24B, 26A-26B and 27A-27B, the composite structure CS with cover comprising base layer T and cover layer TX may provide a surface effect providing a visual effect such as a decorative effect, texture effect, grain effect, color effect, etc. and/or a performance effect such as stain resistance, liquid repellence, anti-fouling, etc. See also FIGS. 16A, 17A, 18A, 18D, 20, 22D and 23B. As indicated schematically in FIGS. 16A, 17A, 18A, 18D, 25A-25F and 28A-28C, the composite structure CS with cover comprising base layer T and cover layer TX may provide a surface effect providing a visual effect such as a decorative effect, texture effect, color effect, etc. and/or a performance effect such as durability/wear resistance, scratch resistance, touch-feel/tactile performance, hardness/softness, friction coefficient, adhesion, etc. See also FIGS. 29A-29B, 30A-30B, 31A-31D, 32, 33, 34, 35A-35B, 36A-36B, 37A-37B and 38A-38B (test methods and apparatus for surface/performance effects of cover of composite structure). As indicated schematically in FIGS. 24A-24B, 26A-26B and 27A-27B, surface effect shown as performance effect such as liquid repellence, stain resistance, etc. for the composite structure CS comprising cover with base layer T and cover layer TX may be determined through use of test/observation with liquid/water drop WT. As indicated schematically in FIGS. 25A-25F and 28A-28C, surface effect shown as performance effect such as scratch resistance, softness/resilience, durability, etc. for the composite structure CS comprising cover with base layer T and cover layer TX may be determined through use of an apparatus such as a force-applying tool/object ZF. See also FIG. 34 (apparatus MP for test method for surface/performance effects of cover of composite structure).

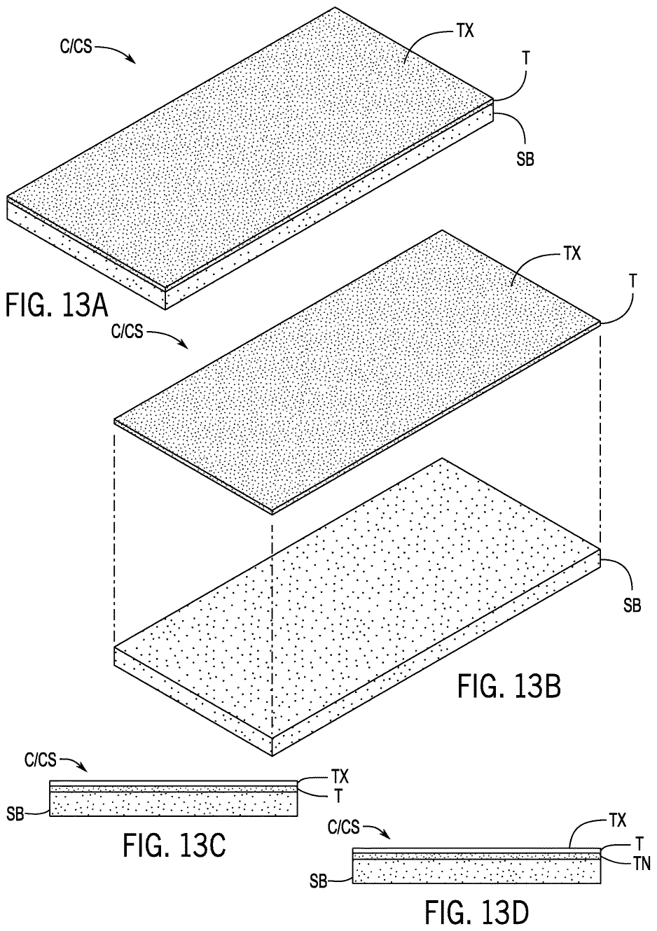

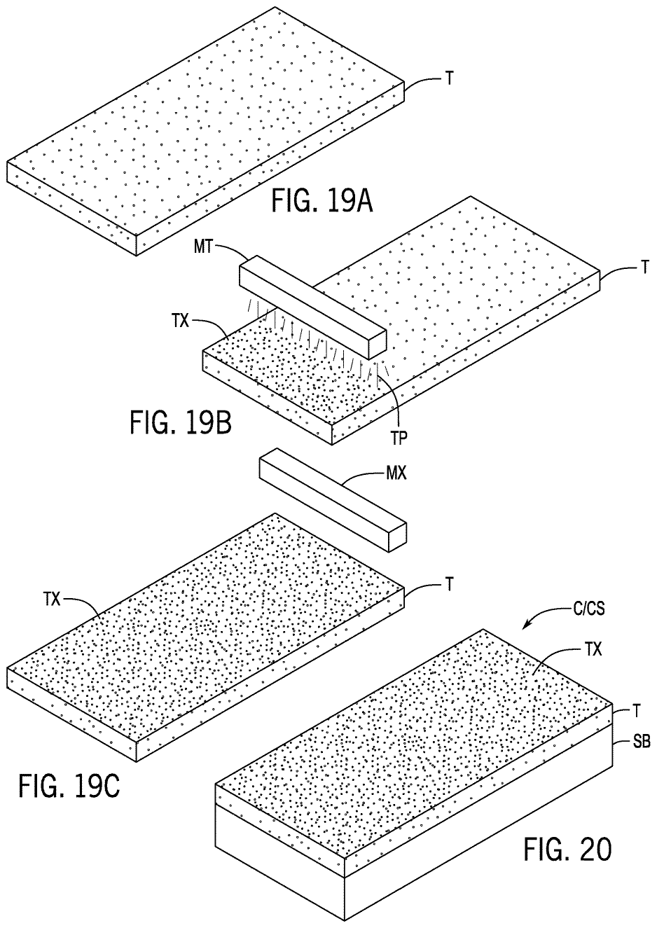

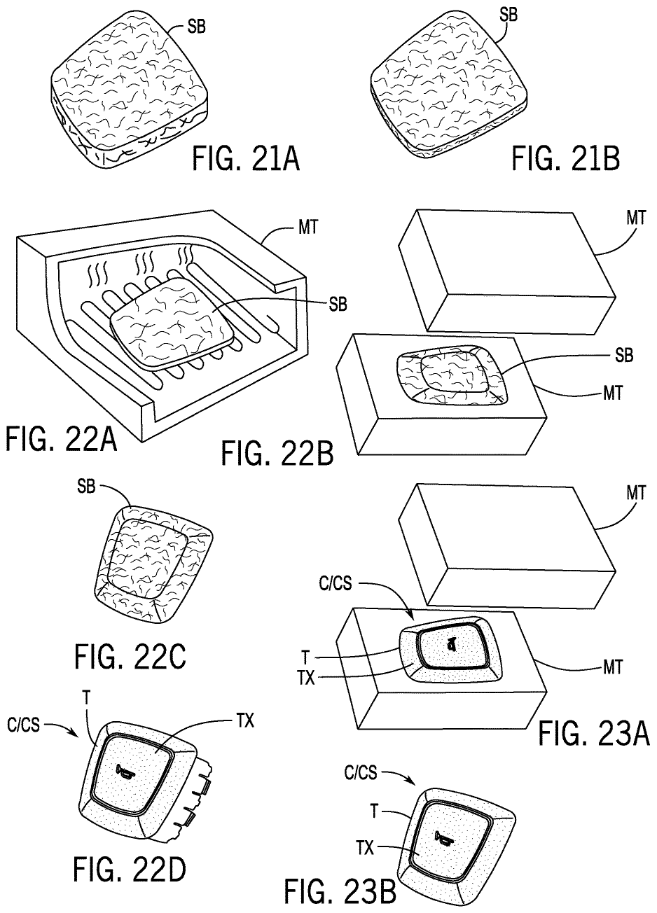

As indicated schematically in FIGS. 13A-13D, 14A-14D, 15A-15D, 16A-16B, 17A-17B, 18A-18E and 20, the cover layer TX may comprise an applied material, formed/molded material, coating, treatment, laminate, film, etc.; the base layer T may comprise a formed/molded material, polymer material, thermoplastic elastomer, foam/soft material, etc.; the composite structure CS may comprise a multi-layer structure comprising a polymer/PET material, fabric layer, non-woven layer, formed/molded materials, soft/cushion layer, barrier/intermediate layer TN in/at the cover, coating/treatment layer, etc.; the substrate SB may comprise a structure, formed/molded structure, panel, formed/molded panel, fiber panel, foam/resilient panel, composite panel, etc. See also FIGS. 13A-13D, 14A-14D, 15A-15D, 16A-16B, 17A-17B, 18A-18E and 20. As indicated schematically in FIGS. 19A-19C, the composite structure CS comprising the cover comprising base layer T and cover layer TX may be produced by application of the cover layer TX as a coating TP from a tool shown as comprising spray head MX. As indicated schematically in FIGS. 21A-21B, 22A-22D and 23A-23B, the composite structure CS comprising the cover comprising base layer T and cover layer TX may be produced by forming of the cover layer TX in a tool shown as comprising a mold MX; as indicated schematically, the substrate SB may be pre-heated to be formed into the structural substrate in the tool shown as oven MX (see FIG. 22A); as indicated schematically, the substrate SB may be compression formed and/or molded into a structural substrate in the tool shown as mold MX (see FIG. 22B); the cover comprising base layer T and cover layer TX may be formed in the tool shown as mold MX such as by injection molding, compression molding, compression forming, etc. (see FIG. 23A); the cover comprising base layer T and cover layer TX may be formed on the substrate SB in the tool shown as mold MX such as by injection molding, compression molding, etc. (see FIG. 23A); surface effect of the cover comprising base layer T and cover layer TX may be formed and/or imparted by the tool shown as mold MX (e.g. shape, form, texture, hardness/softness, color, etc.). See FIGS. 1B, 2, 3, 4, 5, 6, 7A-7B, 8, 9, 10, 11, 12, 16A, 22D and 23B.

As indicated schematically in FIGS. 18A-18E, the composite structure CS comprising the cover comprising cover base layer T and cover layer TX may comprise an intermediate layer such as a barrier layer TN between the base layer T and the cover layer TX. See also FIGS. 29A-29B (intermediate/barrier layer between cover and substrate); as indicated schematically, the barrier layer TN may comprise a material configured to limit penetration of material of the cover layer TX into material of the base layer T during formation of the cover; the barrier layer TN may comprise a material having compatibility with material of the cover layer TX; and the barrier layer TN may comprise a laminate with the base layer T. As indicated schematically in FIGS. 18A-18E, the composite structure CS comprising the cover comprising cover base T and cover layer TX may comprise an intermediate layer TN between cover base T and the substrate SB. As indicated schematically, the composite structure may comprise a structure such a formed structure/reinforcement for the base layer of the cover and/or for the substrate.

As shown schematically in the FIGURES, the component C comprising may comprise a composite structure CS comprising a structural substrate SB and a cover comprising a base layer T and a cover layer TX; the base layer T of the cover may be configured to provide a base for the cover; the cover layer TX of the cover may be configured to provide an exterior surface for the composite structure CS; the cover layer TX of the cover may comprise a cover layer material on the base layer T of the cover; the cover layer material may comprise an applied material and/or a formed material; the base layer T of the cover may comprise a base layer material. The composite structure CS may comprise an interface between the structural substrate SB and the cover the interface may comprise an intermediate layer TN; the cover layer material may comprise an applied material comprising a coating; the cover layer TX may comprise a molded layer and/or an injection molded layer and/or a foam molded layer and/or a cover layer; the base layer T may comprise a molded layer; the base layer material may comprise a polymer material and/or a molded material and/or an injection-molded material and/or a film and/or a polymer material and/or an elastomer and/or a thermoplastic elastomer and/or at least one of TPEE and/or TPU and/or TPV and/or TPE-S; the cover layer TX may comprise a molded layer; the cover layer TX may comprise a polymer material and/or a molded material and/or an injection-molded material and/or a film and/or a polyurethane material and/or an acrylic material comprising silicone and/or a polymer material comprising fluorine and/or a stain-resistant polymer material; the structural substrate SB may comprise a panel and/or a base and/or a fiber panel and/or a compressed fiber panel and/or a reduced-density material and/or a stiffness-retaining material and/or a molded substrate SB; the intermediate layer TN may comprise a resilient material and/or a compressible material and/or a cushioning material and/or a foam material and/or a foam-based material and/or a film; the cover may be configured to provide a surface effect comprising a visual effect and/or a performance effect; the performance effect may comprise stain resistance and/or fluid repellence and/or hardness and/or scratch resistance and/or tactile performance; the structural substrate SB may comprise hemp fiberboard and/or foamed hemp fiberboard and/or foamed glass fiberboard and/or polypropylene and/or polyimide and/or polycarbonate; the base layer T may comprise a polyethylene terephthalate fiber material and/or a nonwoven fabric material and/or a mesh fabric and/or foam material and/or sponge material and/or thermoplastic polyester elastomer and/or a foamed material and/or polyethylene terephthalate fiber nonwoven fabric; the cover layer TX may comprise thermoplastic polyester elastomer and/or thermoplastic vulcanized rubber and/or polyurethane and/or a self-skinned material formed from thermoplastic polyester elastomer; the barrier layer TN may comprise polypropylene and/or polyethylene and/or polyethylene terephthalate and/or thermoplastic polyurethane elastomer and/or thermoplastic polyester elastomer; the barrier layer TN may comprise a material configured to limit penetration of material of the cover layer TX into material of the base layer T during formation of the cover; the barrier layer TN may comprise a material having compatibility with material of the cover layer TX; and the barrier layer TN may comprise a laminate with the base layer T; the interface layer may comprise polypropylene and/or polyethylene and/or polyethylene terephthalate and/or thermoplastic polyurethane elastomer and/or thermoplastic polyester elastomer; the interface layer may comprise a laminate with the structural substrate SB; the cover layer material may comprise antifouling coating characteristics; the surface effect may comprise adhesion evaluation and/or wear resistance and/or stain resistance evaluation and/or water droplet angle and/or feel evaluation and/or static and/or dynamic friction coefficient; the component C may be produced by a method comprising the steps of: providing the base layer material for the cover, providing the cover layer material for the cover on the base layer T of the cover, and providing the cover on the structural substrate SB; the step of providing the cover layer material for the cover on the base layer T of the cover may comprise forming the cover layer material on the base layer T; the step of providing the base layer material for the cover may comprise forming the base layer T from the base layer material on the structural substrate SB; the method may further comprise the step of forming a barrier layer TN between the base layer T and the cover layer TX to form a layer structure.

### Exemplary Embodiments—A

According to an exemplary embodiment as shown schematically in FIGS. 1B, 2, 3, 4, 5, 6, 7A-7B, 8, 9, 10, 11, 12, 24A-24B, 25A-25F, 26A-26B, 27A-27B and 28A-28C, a component C for a vehicle interior comprising a composite structure CS may comprise a substrate/base SB such as a structural substrate and cover comprising a base layer T and a cover layer TX configured to provide a surface effect such as visual effect and/or performance effect for the component. See also FIGS. 13A-13D, 14A-14D, 15A-15D, 16A-16B, 17A-17B, 18A-18E and 20. The cover layer/material may comprise an applied material, formed/molded material, coating, treatment, laminate, film, etc.; the base layer/material may comprise a formed/molded material, polymer material, thermoplastic elastomer, foam/soft material, etc. The composite structure may comprise a multi-layer structure comprising a polymer, material, PET material, fabric layer, non-woven layer, formed/molded materials, soft/cushion layer, barrier/intermediate layer in/at the cover, coating/treatment layer, etc. The substrate may comprise a structure, formed/molded structure, panel, formed/molded panel, fiber panel, foam/resilient panel, composite panel, etc. As indicated schematically in FIGS. 24A-24B, 25A-25F, 26A-26B, 27A-27B and 28A-28C, the surface effect for the component comprising the composite structure with cover comprising base layer and cover layer may comprise stain resistance, liquid repellence, durability/wear resistance, scratch resistance, anti-fouling, touch-feel/tactile performance, hardness/softness, friction coefficient, adhesion, decorative/color effect, etc. See also FIGS. 29A-29B, 30A-30B, 31A-31D, 32, 33, 34, 35A-35B, 36A-36B, 37A-37B and 38A-38B.

As indicated schematically in FIGS. 19A-19C, the composite structure CS comprising the cover comprising base layer T and cover layer TX may be produced by application of the cover layer TX as a coating TP from a tool shown as comprising spray head MX. As indicated schematically in FIGS. 21A-21B, 22A-22D and 23A-23B, the composite structure CS comprising the cover comprising base layer T and cover layer TX may be produced by forming of the cover layer TX in a tool shown as comprising a mold MX; as indicated schematically, the substrate SB may be pre-heated to be formed into the structural substrate in the tool shown as oven MX (see FIG. 22A); as indicated schematically, the substrate SB may be compression formed and/or molded into a structural substrate in the tool shown as mold MX (see FIG. 22B); the cover comprising base layer T and cover layer TX may be formed in the tool shown as mold MX such as by injection molding, compression molding, compression forming, etc. (see FIG. 23A); the cover comprising base layer T and cover layer TX may be formed on the substrate SB in the tool shown as mold MX such as by injection molding, compression molding, etc. (see FIG. 23A); surface effect of the cover comprising base layer T and cover layer TX may be formed and/or imparted by the tool shown as mold MX (e.g. shape, form, texture, hardness/softness, color, etc.). See FIGS. 1B, 2, 3, 4, 5, 6, 7A-7B, 8, 9, 10, 11, 12, 16A, 22D and 23B. As indicated schematically in FIGS. 18A-18E, the cover of the composite structure may comprise an intermediate/barrier layer TN at an interface of the base layer T with the cover layer TX and/or at an interface of the base layer T with the substrate SB.

According to an exemplary embodiment as indicated schematically in FIGS. 13A-13D, 14A-14D, 15A-15D, 16A-16B, 17A-17B, 18A-18E and 20, a component C for a vehicle interior may comprise a composite structure CS shown as a multilayer material comprising a substrate/base SB shown as a structural substrate such as a lightweight skeleton/structure and a cover comprises a base layer T such as a resilient/soft layer and a cover layer TX such as a skin layer; the base layer T may be provided between the structural substrate SB and the cover layer TX; the base layer T may be formed by molding such as injection molding and/or as a layer, etc.; the cover layer TX may be formed by molding such as injection molding and/or as a film/coating, etc.; a layer/membrane such as a barrier layer TN may be provided between the base layer T and the cover layer TX of the cover; a layer/membrane such as an intermediate layer TN may be provided between the substrate SB and the base layer T of the cover; the structural substrate SB may be provided as a base/structure such as a panel such as a fiber panel and/or formed by molding such as injection molding, foam injection molding, and or as a multi-layer substrate with layer SBa and SBb, etc.; the composite structure may comprise structure such a formed structure for the base layer of the cover and/or for the substrate.

According to an exemplary embodiment as indicated schematically in FIGS. 19A-19C, 21A-21B, 22A-22D and 23A-23B, a method may be provided for preparing the composite structure such as the multilayer material comprising the substrate such as the lightweight skeleton/structure material and the cover comprising the base layer such as the resilient soft layer material and the cover layer such as the skin layer material and/or with layer/membrane material; the substrate material may be heated/prepared such as heating/softening; the cover/layer material and/or membrane/layer material may be combined/formed onto the substrate for the composite structure; the substrate such as the pre-treated/heated softened lightweight skeleton material may be molded with the base/soft layer and/or with the layer/membrane of the cover to provide the composite structure for the component as a multilayer material; the method may comprise the step of applying, forming, molding, injection molding, etc. the cover comprising the base layer material and/or the cover layer material and/or the layer/membrane material for the substrate such as the lightweight structure/skeleton. See also FIGS. 20, 22D and 23B.

According to an exemplary embodiment as shown in the FIGURES, the component for a vehicle interior may comprise a composite structure comprising a substrate comprising a structural substrate and a cover provided on the substrate comprising a base layer and a cover layer; the cover layer may comprise an exterior surface; the cover is configured to provide a surface effect at the exterior surface comprising a visual effect and/or a performance effect. The performance effect may comprise stain resistance and/or fluid repellence and/or hardness and/or softness and/or scratch resistance and/or tactile performance and/or antifouling. The surface effect may comprise adhesion and/or wear resistance and/or stain resistance and/or water droplet angle and/or feel evaluation and/or texture and/or static friction coefficient and/or dynamic friction coefficient. The visual effect may comprise color and/or texture effect and/or grain effect. The surface effect is provided by the cover layer. The performance effect is provided by the cover layer and/or the base layer. The cover layer may comprise a film and/or a coating and/or an exterior layer. The cover layer is formed on the base layer. The base layer may comprise a molded layer comprising a polymer material and/or a molded material and/or an injection-molded material and/or a film and/or a polymer material and/or an elastomer and/or a thermoplastic elastomer and/or TPEE and/or TPU and/or TPV and/or TPE-S. The cover layer may comprise a polymer material and/or a molded material and/or an injection-molded material and/or a film and/or a polyurethane material and/or an acrylic material comprising silicone and/or a polymer material comprising fluorine and/or a stain-resistant polymer material and/or polyacrylate and/or polyurethane and/or aziridine and/or isocyanate and/or carbodiimide and/or polyacrylic acid and/or methyl carboxylic acid methyl cellulose and/or acrylic fluoropolymer and/or organosiloxane polymer. The cover may comprises an intermediate layer; wherein the intermediate layer may comprise polypropylene and/or polyethylene and/or polyethylene terephthalate and/or thermoplastic polyurethane elastomer and/or thermoplastic polyester elastomer and/or a layer of material on one side of the base layer and/or a layer of material on each side of the base layer and/or a barrier layer; the barrier layer is configured to limit penetration of material of the cover layer into material of the base layer during formation of the cover; the barrier layer comprises a material having compatibility with material of the cover layer; wherein the barrier layer comprises a laminate with the base layer. The cover layer may comprises a polymer material and/or a molded material and/or an injection-molded material and/or a film and/or a polyurethane material and/or an acrylic material comprising silicone and/or a polymer material comprising fluorine and/or a stain-resistant polymer material and/or polyacrylate and/or polyurethane and/or aziridine and/or isocyanate and/or carbodiimide and/or polyacrylic acid and/or methyl carboxylic acid methyl cellulose and/or acrylic fluoropolymer and/or organosiloxane polymer. The substrate material and/or the cover of the base layer material and/or the cover layer material and/or the layer/membrane/diaphragm/layer material may comprise a forming/foaming agent and/or a polymer material and/or materials to provide desired properties for the composite structure/combination. A cover/skin layer material may be applied, formed, molded/injection molded for the cover as the exterior surface of the composite structure with the substrate such as lightweight skeleton; the cover material may comprise an applied/formed/foamed material on the substrate of the composite structure.

According to an exemplary embodiment as indicated schematically in the FIGURES, the material of the substrate and/or base layer may comprise hemp fiberboard or foamed hemp fiberboard or foamed glass fiberboard or polypropylene or polyimide or polycarbonate or a combination; the material of the base layer and/or the intermediate layer may comprise polypropylene or polyethylene or polyethylene terephthalate or thermoplastic polyurethane elastomer or thermoplastic polyester elastomer or a combination; the material of the base layer and/or the cover layer may comprise thermoplastic polyester elastomer or thermoplastic vulcanized rubber or polyurethane or a combination.

### Exemplary Embodiments—B

According to an exemplary embodiment as shown schematically in the FIGURES, a component for a vehicle interior may comprise a composite structure; the composite structure may comprise a substrate; the substrate may comprise a structural substrate; the composite structure may comprise a cover provided on the substrate; the cover provided on the substrate may comprise a base layer and a cover layer; the cover layer may comprise an exterior surface; the cover may be configured to provide a surface effect at the exterior surface may comprise a visual effect and/or a performance effect. The performance effect may comprise stain resistance and/or fluid repellence and/or hardness and/or softness and/or scratch resistance and/or tactile performance and/or antifouling; the surface effect may comprise adhesion evaluation and/or wear resistance and/or stain resistance evaluation and/or water droplet angle and/or feel evaluation and/or texture and/or static friction coefficient and/or dynamic friction coefficient; the visual effect may comprise color and/or texture effect and/or grain effect; the surface effect may be provided by the cover layer; the performance effect may be provided by the cover layer and/or the base layer; the cover layer may comprise a coating; the cover layer may comprise an applied coating; the cover may comprise an intermediate layer; the cover may be formed on the substrate; the cover layer may be formed on the base layer; the cover layer may be formed on the base layer by a coating process; the cover layer may comprise an applied material may comprise a coating; the cover layer may comprise a molded layer and/or an injection molded layer and/or a foam molded layer and/or a skin layer; the base layer may comprise a molded layer; the base layer may comprise a polymer material and/or a molded material and/or an injection-molded material and/or a film and/or a polymer material and/or an elastomer and/or a thermoplastic elastomer and/or TPEE and/or TPU and/or TPV and/or TPE-S; the cover layer may comprise a polymer material and/or a molded material and/or an injection-molded material and/or a film and/or a polyurethane material and/or an acrylic material may comprise silicone and/or a polymer material may comprise fluorine and/or a stain-resistant polymer material; the cover layer may comprise polyacrylate and/or polyurethane and/or aziridine and/or isocyanate and/or carbodiimide and/or polyacrylic acid and/or methyl carboxylic acid methyl cellulose and/or acrylic fluoropolymer and/or organosiloxane polymer; the structural substrate may comprise a panel and/or a base and/or a fiber panel and/or a compressed fiber panel and/or a reduced-density material and/or a stiffness-retaining material and/or a molded substrate and/or a composite panel and/or polymer material and/or a structure; the structural substrate may comprise hemp fiberboard and/or foamed hemp fiberboard and/or foamed glass fiberboard and/or polypropylene and/or polyimide and/or polycarbonate; the cover may comprise a hard segment and a soft segment; the base layer may comprise the hard segments and/or the soft segment; the cover may comprise a polymer material; the polymer material may comprise a thermoplastic elastomeric material; the polymer material may comprise a thermoplastic polyester elastomer; the thermoplastic polyester elastomer may comprise a hard segment and a soft segment; the polymer material may be configured for recyclability as a sub-assembly; the polymer material may be selected from a group of polymer materials may comprise a polyolefin group and/or a thermoplastic elastomeric group and/or an elastomeric group; the cover may comprise a texture provided at the external surface; the cover layer may comprise the texture; the cover may comprise a foam structure; the base layer may comprise the foam structure; the foam structure may comprise a foamed structure; the base layer of the cover may comprise a polymer material; the base layer of the cover may comprise a thermoplastic material; the base layer of the cover may comprise a thermoplastic elastomeric material; the base layer of the cover may comprise a thermoplastic polyester elastomer; the thermoplastic polyester elastomer may comprise a hard segment and a soft segment; the cover layer may comprise a film; the cover layer may comprise a coating; the cover layer may comprise the exterior layer; the cover layer may comprise the applied coating; the cover may comprise a coating system to provide a coating for the cover layer; the coating may comprise a film-forming agent and a crosslinking agent; the coating may comprise a solvent and an anti-fouling agent; the coating may comprise a solvent and a leveling agent; the coating may comprise a solvent and a silane-based auxiliary agent; the coating may comprise water or ethanol or isopropanol or a combination; the coating may comprise polyacrylate or polyurethane or a combination; the coating may comprise aziridine or isocyanate or carbodiimide or a combination; the coating may comprise polyacrylic acid or methyl carboxylic acid methyl cellulose or a combination; the coating may comprise an acrylic fluoropolymer or an organosiloxane polymer or a combination.

According to an exemplary embodiment as shown schematically in the FIGURES, a component for a vehicle interior may comprise a composite structure; the composite structure may comprise a substrate; the substrate may comprise a structural substrate; the composite structure may comprise a cover provided on the substrate; the cover provided on the substrate may comprise a base layer and a cover layer; the cover layer may comprise an exterior surface; the cover may be configured to provide a surface effect at the exterior surface may comprise a visual effect and/or a performance effect. The base layer of the cover may comprise a polymer material; the base layer of the cover may comprise a thermoplastic material; the base layer of the cover may comprise a thermoplastic elastomeric material; the base layer of the cover may comprise a thermoplastic polyester elastomer; the thermoplastic polyester elastomer may comprise a hard segment and a soft segment; the cover may comprise the surface effect; the cover may comprise the surface effect at the exterior surface; the surface effect may comprise the visual effect; the surface effect may comprise the performance effect; the surface effect may comprise the visual effect and the performance effect; the visual effect may comprise a decorative effect; the visual effect may comprise a texture effect; the visual effect may comprise a color effect; the visual effect may comprise the decorative effect and the texture effect; the performance effect may comprise stain resistance; the performance effect may comprise abrasion resistance; the performance effect may comprise weather resistance; the performance effect may comprise gloss retention; the performance effect may comprise a friction coefficient; the performance effect may comprise a water droplet angle; the performance effect may comprise adhesion; the performance effect may comprise anti-fouling; the performance effect may comprise scratch resistance; the performance effect may comprise liquid repellence; the performance effect may comprise stain resistance and abrasion resistance; the performance effect may comprise abrasion resistance and gloss retention; the performance effect may comprise a friction coefficient and a water droplet angle; the performance effect may comprise stain resistance and anti-fouling; the performance effect may comprise wear resistance and scratch resistance; the cover layer may comprise the visual effect and the decorative effect; the cover layer may comprise the visual effect and the texture effect; the cover layer may comprise the visual effect and the color effect; the cover layer may comprise the performance effect of liquid repellence; the cover layer may comprise the performance effect of stain resistance; the cover layer may comprise the performance effect of abrasion resistance; the cover layer may comprise the performance effect of anti-fouling; the cover layer may comprise the performance effect and the visual effect; the cover layer may comprise a coating to provide the surface effect at the exterior surface of the cover; the surface effect at the exterior surface of the cover may comprise stain resistance; the surface effect at the exterior surface of the cover may comprise abrasion resistance; the surface effect at the exterior surface of the cover may comprise weather resistance; the surface effect at the exterior surface of the cover may comprise gloss retention; the surface effect at the exterior surface of the cover may comprise a friction coefficient; the surface effect at the exterior surface of the cover may comprise a water droplet angle; the surface effect at the exterior surface of the cover may comprise stain resistance and abrasion resistance; the surface effect at the exterior surface of the cover may comprise abrasion resistance and gloss retention; the surface effect at the exterior surface of the cover may comprise a friction coefficient and a water droplet angle; the surface effect at the exterior surface of the cover may comprise water droplet angle measured by a droplet method; the surface effect at the exterior surface of the cover may comprise shedding of liquid drops under inclination testing; the surface effect at the exterior surface of the cover may comprise a gloss value retained after a Taber wear test conducted with a 500 g load and 500 cycles; the surface effect at the exterior surface of the cover may comprise no visible wear after a Taber wear test conducted with a 500 g load and 500 cycles; the surface effect at the exterior surface of the cover may comprise the peel grade after a room-temperature grid test; the surface effect at the exterior surface of the cover may comprise the peel grade after a humidity grid test; the surface effect at the exterior surface of the cover may comprise the peel grade after a thermal-aging grid test; the surface effect at the exterior surface of the cover may comprise a stick-slip response corresponding to the maximum acceleration; the surface effect at the exterior surface of the cover may comprise a stick-slip response corresponding to the maximum dynamic friction coefficient; the surface effect at the exterior surface of the cover may comprise a stick-slip response corresponding to the maximum static friction coefficient; the surface effect at the exterior surface of the cover may comprise a water droplet angle above 100 degrees at room temperature; the surface effect at the exterior surface of the cover may comprise a water droplet angle of 110 degrees or more at room temperature; the surface effect at the exterior surface of the cover may comprise a gloss change rate of 20 percent or less according to ISO 5470-1-2016.

According to an exemplary embodiment as shown schematically in the FIGURES, a component for a vehicle interior may comprise a composite structure; the composite structure may comprise a substrate; the substrate may comprise a structural substrate; the composite structure may comprise a cover provided on the substrate; the cover provided on the substrate may comprise a base layer and a cover layer; the cover layer may comprise an exterior surface; the cover may be configured to provide a surface effect at the exterior surface may comprise a visual effect and/or a performance effect. The base layer may comprise a polyethylene terephthalate fiber material and/or a nonwoven fabric material and/or a mesh fabric and/or foam material and/or sponge material and/or thermoplastic polyester elastomer and/or a foamed material and/or polyethylene terephthalate fiber nonwoven fabric; the cover layer may comprise thermoplastic polyester elastomer and/or thermoplastic vulcanized rubber and/or polyurethane and/or a self-skinned material formed from thermoplastic polyester elastomer; the intermediate layer may comprise polypropylene and/or polyethylene and/or polyethylene terephthalate and/or thermoplastic polyurethane elastomer and/or thermoplastic polyester elastomer the barrier layer may comprise a material configured to limit penetration of material of the cover layer into material of the base layer during formation of the cover; the barrier layer may comprise a material having compatibility with material of the cover layer; and the barrier layer may comprise a laminate with the base layer; the intermediate layer may comprise a resilient material and/or a compressible material and/or a cushioning material and/or a foam material and/or a foam-based material and/or a film; the intermediate layer may comprise polypropylene and/or polyethylene and/or polyethylene terephthalate and/or thermoplastic polyurethane elastomer and/or thermoplastic polyester elastomer; the interface layer may comprise a laminate with the structural substrate; the base layer may comprise a skin layer formed from a thermoplastic polyester elastomer by an injection molding process and the cover layer may comprise a coating on the base layer; the cover may comprise at least one layer; the cover may comprise a multi-layer cover; the cover may comprise a molded cover; the cover may comprise an injection molded layer; the cover may comprise an in-mold injection molded layer; the cover may comprise an in-mold foam injection molded layer; the cover may comprise a foamed structure; the cover may comprise a skin layer; the cover may comprise a molded skin layer; the cover may comprise an injection molded skin layer; the cover may comprise an in-mold injection molded skin layer; the cover may comprise an in-mold foam injection molded skin layer; the cover may comprise a soft foam layer and junction skin layer; the cover may comprise an intermediate layer; the cover may comprise an intermediate layer on each side of the base layer of the cover; the intermediate layer may comprise a self-junction skin layer; the cover may comprise a thermoplastic elastomeric material; the cover may comprise a thermoplastic polyester elastomer; the cover may comprise TPEE; the cover may comprise a film-forming agent and a crosslinking agent; the cover may comprise a solvent and an anti-fouling agent; the cover may comprise a solvent and a leveling agent; the cover may comprise a solvent and a silane-based auxiliary agent; the cover may comprise water or ethanol or isopropanol or a combination; the cover may comprise polyacrylate or polyurethane or a combination; the cover may comprise aziridine or isocyanate or carbodiimide or a combination; the cover may comprise an acrylic fluoropolymer or an organosiloxane polymer or a combination; the cover may comprise a polymer material may comprise thermoplastic polyester elastomer; the cover may comprise a polymer material may comprise thermoplastic polyester elastomer may comprise a chain segment; the chain segment of the thermoplastic polyester elastomer may comprise an active functional group; the active functional group may comprise a hydroxyl group, a carboxyl group, an amine group, or a combination; the thermoplastic polyester elastomer may comprise a hard segment and a soft segment; the hard segment of the thermoplastic polyester elastomer may comprise: poly (butylene terephthalate), poly(ethylene terephthalate), poly (trimethylene terephthalate), poly (trimethylene terephthalate)/poly (butylene terephthalate), poly(2,6-naphthalate), poly (trimethylene terephthalate), poly(ethylene terephthalate)/polybutylene terephthalate copolymers, poly (dimethyl terephthalate/m-xylylene)/1,4-butanediol copolymers, poly(2,5-furan dicarboxylate), poly(2,5-furandicarboxylic acid) propylene glycol ester, poly(2,5-furandicarboxylate), poly(2,5-furan dicarboxylate), or a combination; As indicated schematically, the method may comprise: polybutylene terephthalate, poly(2,5-furandicarboxylate), or a combination; the soft segment of the thermoplastic polyester elastomer may comprise: polyethylene glycol, polybutylene glycol, polycaprolactone, polyethylene glycol, fatty acid dimer diol, polytetramethylene ether, ethylene oxide-propylene oxide copolymer bisphenol A ether, polypropylene glycol, polylactide, polyglycolide, or a combination; polyethylene glycol, polycaprolactone, polytetramethylene ether, or a combination; the cover may comprise a thermoplastic polyester elastomer may comprise an active functional group; the cover may comprise a crosslinking agent selected to react with the active functional group; the cover may comprise the active functional group and the cover may comprise the crosslinking agent selected to react with the active functional group; the cover may comprise a film-forming agent in an amount of 30-45 wt percent; the cover may comprise a crosslinking agent in an amount of 3-15 wt percent; the cover may comprise a thickness of 1.5-2.5 mm and the applied coating may comprise an elongation at break of 100-200 percent; the cover may comprise a thickness of 1.2-1.5 mm and the applied coating may comprise an elongation at break of 200-300 percent; the cover may comprise a thickness of 0.3-1.2 mm and the applied coating may comprise an elongation at break of 300-500 percent; the cover may comprise a thickness of 0.3-2.5 mm; the cover may comprise a resin and a plasticizer; the cover may comprise a melt index of 50-400 g/10 min measured at 220 degrees C. and 2.16 kg; the cover may comprise a density of 0.95-1.15 g/cc; the cover may comprise a texture replicated during injection molding; the cover may comprise a spray-coated applied coating.

According to an exemplary embodiment as shown schematically in the FIGURES, a component for a vehicle interior may comprise a composite structure; the composite structure may comprise a substrate; the substrate may comprise a structural substrate; the composite structure may comprise a cover provided on the substrate; the cover provided on the substrate may comprise a base layer and a cover layer; the cover layer may comprise an exterior surface; the cover may be configured to provide a surface effect at the exterior surface may comprise a visual effect and/or a performance effect. The base layer of the cover may comprise a skin layer; the base layer of the cover may comprise a texture; the base layer of the cover may comprise a foamed structure; the base layer of the cover may comprise a polymer material; the base layer of the cover may comprise a thermoplastic material; the base layer of the cover may comprise a thermoplastic elastomeric material; the base layer of the cover may comprise a thermoplastic polyester elastomer; the base layer of the cover may comprise TPEE; the base layer of the cover may comprise a layer; the base layer of the cover may comprise a molded layer; the base layer of the cover may comprise an injection molded layer; the base layer of the cover may comprise an in-mold injection molded layer; the base layer of the cover may comprise an in-mold foam injection molded layer; the base layer of the cover may comprise a film-forming agent and a crosslinking agent; the base layer of the cover may comprise a solvent and an anti-fouling agent; the base layer of the cover may comprise a solvent and a leveling agent; the base layer of the cover may comprise a solvent and a silane-based auxiliary agent; the base layer of the cover may comprise water or ethanol or isopropanol or a combination; the base layer of the cover may comprise polyacrylate or polyurethane or a combination; the base layer of the cover may comprise a texture; the base layer of the cover may comprise a foamed structure; the base layer of the cover may comprise a soft foam layer and junction skin layers; the base layer of the cover may comprise a thickness of 0.3 mm to 2.5 mm; the base layer of the cover may comprise a resin and a plasticizer; the base layer of the cover may comprise an additional resin or a plasticizer or a combination; the base layer of the cover may comprise a melt index of 50 g/10 min to 400 g/10 min measured at 220 degrees C. and 2.16 kg; the base layer of the cover may comprise a density of 0.95 g/cm\hat{ }3 to 1.15 g/cm\hat{ }3; the base layer of the cover may comprise a tensile strength of 3 MPa to 10 MPa; the base layer of the cover may comprise an elongation at break of 100 percent to 800 percent; the base layer of the cover may comprise a tear strength of 20 kN/m to 60 kN/m; the base layer of the cover may comprise a texture replicated during injection molding; the base layer of the cover may comprise a thermoplastic polyester elastomer formed by an injection molding process and the cover layer of the cover may comprise a coating; the base layer of the cover may comprise a soft foam layer.

According to an exemplary embodiment as shown schematically in the FIGURES, a component for a vehicle interior may comprise a composite structure; the composite structure may comprise a substrate; the substrate may comprise a structural substrate; the composite structure may comprise a cover provided on the substrate; the cover provided on the substrate may comprise a base layer and a cover layer; the cover layer may comprise an exterior surface; the cover may be configured to provide a surface effect at the exterior surface may comprise a visual effect and/or a performance effect. The cover layer may comprise a cover layer material; the cover layer material may comprise a film and/or an applied film and/or a coating and/or an applied coating and/or a formed layer; the cover layer material may comprise: a compatible resin and/or a plasticizer or a combination; the compatible resin may comprise: polybutylene terephthalate and/or polyethylene terephthalate and/or polyamide and/or acrylonitrile-butadiene-styrene copolymer and/or polycarbonate and/or epoxy resin or a combination; the plasticizer may comprise an ortho-benzoate compound and/or a phthalic acid compound and/or an aliphatic dibasic acid compound and/or an epoxy ester compound and/or a phosphate ester compound or a combination; the cover layer material may comprise a melt index of 50-400 g/10 min and/or 200-300 g/10 min, measured at 220 degrees C. and 2.16 kg; the density of the cover layer material may be 0.95-1.15 g/cm and/or 1.05-1.15 g/cm; the cover layer of the cover may comprise a coating system may comprise a coating; the coating of the coating system may comprise a solid content of 10-30 wt percent; the coating of the coating system may comprise an applied coating; the applied coating may comprise a thickness of 5-18 μm; the applied coating may comprise a density of 0.7-1.3 g/cc; the coating may comprise a thickness of 5 to 18 μm and/or the density of the coating may be 0.7-1.3 g/cm and/or 0.9-1.1 g/cm; the coating may be formed by a spray coating process; the cover layer may comprise a texture formed at the coating; the coating may be formed from a coating system; the coating system may comprise: a film-forming agent and a crosslinking agent; the film-forming agent may comprise: polyacrylate and/or polyurethane or a combination; the crosslinking agent may comprise aziridine and/or isocyanate and/or carbodiimide or a combination; the coating system further may comprise: a solvent and/or a feel agent and/or a leveling agent and/or an anti-fouling agent or a combination; the solvent may comprise water and/or ethanol and/or isopropanol or a combination; the hand-feel agent may comprise a silane-based auxiliary agent; the leveling agent may comprise: polyacrylic acid and/or methyl carboxylic acid methyl cellulose or a combination; the anti-fouling agent may comprise an acrylic fluoropolymer and/or an organosiloxane polymer or a combination; thickness of the cover may be 1.5-2.5 mm and elongation at break of the coating may be 100-200 percent; thickness of the cover may be 1.2-1.5 mm and elongation at break of the coating may be 200-300 percent; thickness of the cover may be 0.3-1.2 mm and elongation at break of the coating may be 300-500 percent.

According to an exemplary embodiment as shown schematically in the FIGURES, a component for a vehicle interior may comprise a composite structure; the composite structure may comprise a substrate; the substrate may comprise a structural substrate; the composite structure may comprise a cover provided on the substrate; the cover provided on the substrate may comprise a base layer and a cover layer; the cover layer may comprise an exterior surface; the cover may be configured to provide a surface effect at the exterior surface may comprise a visual effect and/or a performance effect. The component may comprise a vehicle interior component; the component may comprise an instrument panel and/or a trim panel and/or a door panel component and/or a console and/or a floor console and/or a center console and/or an overhead console and/or an armrest and/or a seat assembly; the vehicle may comprise an automobile and/or a work vehicle and/or a passenger vehicle and/or an aircraft and/or a vessel and/or a ship and/or a cycle and/or an electric vehicle and/or a rail vehicle and/or a train and/or a subway car and/or a light rail section and/or a car.

According to an exemplary embodiment as shown schematically in the FIGURES, a component for a vehicle interior may comprise a composite structure; the composite structure may comprise a substrate; the substrate may comprise a structural substrate; the composite structure may comprise a cover provided on the substrate; the cover provided on the substrate may comprise a base layer and a cover layer; the cover layer may comprise an exterior surface; the cover may be configured to provide a surface effect at the exterior surface may comprise a visual effect and/or a performance effect. The component may be produced by a method comprising the steps of providing a base layer material for the base layer of the cover, providing the cover layer material for the cover layer on the base layer and providing the cover on the structural substrate; the step of providing the cover layer material on the base layer may comprise forming the cover layer material on the base layer; the step of providing the base layer material may comprise forming the base layer from the base layer material on the structural substrate; the cover may be configured to provide the surface effect for the composite structure; the method may comprise molding to form the base layer of the cover; the method may comprise injection molding to form the base layer of the cover; the method may comprise forming a texture in the base layer of the cover; the method may comprise forming a texture in the cover layer of the cover; the method may comprise foaming to form the base layer of the cover; the method may comprise forming the soft foam layer and the junction skin layers in the base layer of the cover; the method may comprise spray coating to form the cover; the method may comprise curing the applied coating; the method may comprise forming the cover layer directly on the base layer of the cover; the method may comprise providing the intermediate layer on the base layer of the cover and forming the cover layer on the intermediate layer; the base layer of the cover may comprise a thermoplastic elastomeric material; the base layer of the cover may comprise a thermoplastic polyester elastomer; the cover may comprise a film-forming agent and a crosslinking agent; the cover may comprise a solvent and an anti-fouling agent; the base layer of the cover may comprise a thermoplastic polyester elastomer may comprise an active functional group; the base layer of the cover may comprise the active functional group and the cover may comprise a crosslinking agent selected to react with the active functional group; the method may comprise in-mold injection molding to form the base layer of the cover; the method may comprise in-mold foam injection molding to form the base layer of the cover; the method may comprise forming the cover by a coating process on the base layer of the cover; the method may comprise spray coating to form the cover; the method may comprise curing the applied coating; the method may comprise forming the cover layer on the base layer of the cover; the method may comprise providing the intermediate layer on the base layer of the cover and forming the cover layer on the intermediate layer; the method may comprise forming the cover layer as a film on the base layer of the cover; the method may comprise forming the cover layer as a coating on the base layer of the cover; the method may comprise forming the applied coating on the base layer of the cover; the method may comprise forming the cover layer to provide the surface effect at the exterior surface of the cover; the method may comprise forming the cover layer to provide the surface effect at the exterior surface of the cover; the method may comprise combining the intermediate layer with the base layer of the cover; the method may comprise combining the cover layer with the intermediate layer; the method may comprise laminating a layer of the cover; the method may comprise assembling the structural substrate into the component; the surface effect at the exterior surface of the cover may comprise the maximum dynamic friction coefficient and the maximum static friction coefficient; the cover layer may comprise a dry film thickness of 3 um to 30 um; the cover layer may comprise a dry film thickness of 8 um to 15 um; the cover layer may comprise a Shore A hardness of 40 to 80; the base layer of the cover may comprise a thickness of 1.5 mm to 3 mm; the base layer of the cover may comprise a flexural modulus of at least 1800 MPa; the base layer of the cover may comprise a density of less than 0.85 g/cc; the base layer of the cover may comprise hemp fiberboard or foamed hemp fiberboard or foamed glass fiberboard or polypropylene or polyimide or polycarbonate or a combination; the intermediate layer may comprise polypropylene or polyethylene or polyethylene terephthalate or thermoplastic polyurethane elastomer or thermoplastic polyester elastomer or a combination; the cover layer may comprise thermoplastic polyester elastomer or thermoplastic vulcanized rubber or polyurethane or a combination; the cover layer may comprise a self-skinned surface formed after foaming; the cover may comprise a composite form may comprise at least two layers; the composite structure may comprise a multi-layer material.

According to an exemplary embodiment as shown schematically in the FIGURES, a component for a vehicle interior may comprise a composite structure may comprise a cover; the cover may comprise a base layer and a cover layer; the cover layer may comprise an exterior surface; the cover may be configured to provide a surface effect; the surface effect may comprise a visual effect and/or a performance effect; the cover may comprise a performance effect; the performance effect may comprise stain resistance and/or fluid repellence and/or hardness and/or scratch resistance and/or tactile performance; the component may further comprise a substrate; the substrate may comprise a structural substrate; the cover may be provided on the substrate. The surface effect may comprise adhesion evaluation and/or wear resistance and/or stain resistance evaluation and/or water droplet angle and/or feel evaluation and/or friction coefficient.

According to an exemplary embodiment as shown schematically in the FIGURES, a composite structure for a component for an interior of a vehicle may comprise a cover; the cover may comprise a base layer and a cover layer; the base layer may comprise a skin layer formed from a thermoplastic polyester elastomer by an injection molding process; the cover layer may comprise a coating on a surface of the base layer of the cover; the composite structure may further comprise a substrate configured to provide a structural substrate for the cover; the cover may be formed on the substrate; the cover may be molded on the substrate; the cover may comprise a skin material; the base layer of the cover may comprise a soft foam layer; the cover may comprise a self-junction skin layer located on two sides of the soft foam layer; the cover may comprise a polymer material; the polymer material may comprise a thermoplastic polyester elastomer; a chain segment of the thermoplastic polyester elastomer may comprise an active functional group preferably the active functional group may comprise a hydroxyl group and/or a carboxyl group and/or an amine group or a combination; the thermoplastic polyester elastomer may comprise a hard segment and a soft segment; the hard segment of the thermoplastic polyester elastomer may comprise: poly (butylene terephthalate) and/or poly(ethylene terephthalate) and/or poly (trimethylene terephthalate) and/or poly (trimethylene terephthalate)/poly (butylene terephthalate) and/or poly(2,6-naphthalate) and/or poly (trimethylene terephthalate) and/or poly(ethylene terephthalate)/polybutylene terephthalate copolymers and/or poly (dimethyl terephthalate/m-xylylene)/1,4-butanediol copolymers and/or poly (2,5-furan dicarboxylate) and/or poly(2,5-furandicarboxylic acid) propylene glycol ester and/or poly(2,5-furandicarboxylate) and/or poly(2,5-furan dicarboxylate) or a combination; preferably, the method may comprise: polybutylene terephthalate and/or poly(2,5-furandicarboxylate) or a combination; the soft segment of the thermoplastic polyester elastomer may comprise: polyethylene glycol and/or polybutylene glycol and/or polycaprolactone and/or polyethylene glycol and/or fatty acid dimer diol and/or polytetramethylene ether and/or ethylene oxide-propylene oxide copolymer bisphenol A ether and/or polypropylene glycol and/or polylactide and/or polyglycolide or a combination; polyethylene glycol and/or polycaprolactone and/or polytetramethylene ether and/or or a combination; the material for forming the cover layer of the cover further may comprise: a compatible resin and/or a plasticizer or a combination; the compatible resin may comprise: polybutylene terephthalate and/or polyethylene terephthalate and/or polyamide and/or acrylonitrile-butadiene-styrene copolymer and/or polycarbonate and/or epoxy resin or a combination; the plasticizer may comprise: an ortho-benzoate compound and/or a phthalic acid compound and/or an aliphatic dibasic acid compound and/or an epoxy ester compound and/or a phosphate ester compound or a combination; the material for forming the cover layer of the cover may comprise a melt index of 50-400 g/10 min and/or 200-300 g/10 min, measured at 220 degrees C. and 2.16 kg; and/or the density of the material forming the cover layer of the cover may be 0.95-1.15 g/cm and/or 1.05-1.15 g/cm; the polymer material configured for recyclability as a sub-assembly may be selected from a group of polymer materials and may comprise a polyolefin group and/or a thermoplastic elastomeric group and/or an elastomeric group; the coating may be formed from a coating system; the coating system may comprise a film-forming agent and a crosslinking agent; the film-forming agent may comprise polyacrylate and/or, polyurethane or a combination; the crosslinking agent may comprise aziridine and/or isocyanate and/or carbodiimide or a combination; the coating system further may comprise a solvent and/or a feel agent and/or a leveling agent and/or an anti-fouling agent or a combination; the solvent may comprise water and/or ethanol and/or isopropanol or a combination; the hand-feel agent may comprise a silane-based auxiliary agent; the leveling agent may comprise polyacrylic acid and/or methyl carboxylic acid methyl cellulose or a combination; the anti-fouling agent may comprise an acrylic fluoropolymer and/or an organosiloxane polymer or a combination; the coating may be formed by a spray coating process; the cover may comprise a texture; the cover may comprise aziridine and/or isocyanate and/or carbodiimide or a combination; the cover may comprise polyacrylic acid or methyl carboxylic acid methyl cellulose or a combination; the cover may comprise an acrylic fluoropolymer or an organosiloxane polymer or a combination; the cover may comprise a solid content of 10 wt percent to 30 wt percent; the cover layer may comprise a thickness of 5 um to 18 um; the cover layer may comprise a density of 0.7 g/cc to 1.3 g/cc; the cover may comprise a film-forming agent in an amount of 30 wt percent to 45 wt percent; the cover may comprise a crosslinking agent in an amount of 3 wt percent to 15 wt percent; the base layer of the cover may comprise a thickness of 1.5 mm to 2.5 mm and the cover layer may comprise an elongation at break of 100 percent to 200 percent; the base layer of the cover may comprise a thickness of 1.2 mm to 1.5 mm and the cover layer may comprise an elongation at break of 200 percent to 300 percent; the base layer of the cover may comprise a thickness of 0.3 mm to 1.2 mm and the cover layer may comprise an elongation at break of 300 percent to 500 percent; the surface effect at the exterior surface of the cover may comprise a water droplet angle above 100 deg C. at room temperature; the surface effect at the exterior surface of the cover may comprise a water droplet angle of 110 deg C. or more at room temperature; the surface effect at the exterior surface of the cover may comprise a gloss change rate of 20 percent or less according to ISO 5470-1-2016; the surface effect at the exterior surface of the cover may comprise a peel grade of Grade 1 or Grade 0 according to ISO 2409:1992; the surface effect at the exterior surface of the cover may comprise a maximum acceleration of 0.05 to 1.50 according to VDA 230-206; the surface effect at the exterior surface of the cover may comprise a maximum dynamic friction coefficient of 0.2 to 1.2 according to VDA 230-206; the surface effect at the exterior surface of the cover may comprise a maximum static friction coefficient of 0.2 to 1.50 according to VDA 230-206; the surface effect at the exterior surface of the cover may comprise water droplet angle and gloss change rate; the surface effect at the exterior surface of the cover may comprise peel grade maximum acceleration; the performance effect of the cover may comprise a water droplet angle of the cover at room temperature may be above 100 degrees C. and/or 110 degrees C. or more; the cover may comprise a gloss change rate of 20 percent or less and/or 15 percent or less according to ISO 5470-1-2016; the peel grade of the cover according to ISO 2409:1992 may be Grade 1 or Grade 0; the maximum acceleration measured by the cover according to the standard VDA 230-206; stick-slip test standard may be 0.05-1.50; preferably 0.08-1.00; the maximum dynamic friction coefficient measured by the cover according to the standard VDA 230-206; stick-slip test standard may be 0.2-1.2 and/or 0.3-1.0; the maximum static friction coefficient measured by the cover according to the standard VDA 230-206; stick-slip test standard may be 0.2-1.50 and/or 0.3-1.2.

### Exemplary Embodiments—C

According to an exemplary embodiment as shown schematically in FIGS. 1B, 2, 3, 4, 5, 6, 7A-7B, 8, 9, 10, 11, 12, 24A-24B, 25A-25F, 26A-26B, 27A-27B and 28A-28C, a component C such as a trim component/vehicle trim for a vehicle interior comprising a composite structure CS may comprise a substrate/base SB such as a structural substrate and a cover such as a skin material comprising a base layer T such as a cover/substrate and a cover layer TX such as a skin layer configured to provide a surface effect such as visual effect and/or performance effect for the component. See also FIGS. 13A-13D, 14A-14D, 15A-15D, 16A-16B, 17A-17B, 18A-18E and 20. The cover layer/material may comprise an applied material, formed/molded material, coating, treatment, laminate, film, etc.; the base layer/material may comprise a formed/molded material, polymer material, thermoplastic elastomer, foam/soft material, etc. The composite structure may comprise a multi-layer structure comprising a polymer, material, PET material, fabric layer, non-woven layer, formed/molded materials, soft/cushion layer, barrier/intermediate layer in/at the cover, coating/treatment layer, etc. The substrate may comprise a structure, formed/molded structure, panel, formed/molded panel, fiber panel, foam/resilient panel, composite panel, etc. As indicated schematically in FIGS. 24A-24B, 25A-25F, 26A-26B, 27A-27B and 28A-28C, the surface effect for the component comprising the composite structure with cover comprising base layer and cover layer may comprise stain resistance, liquid repellence, durability/wear resistance, scratch resistance, anti-fouling, touch-feel/tactile performance, hardness/softness, friction coefficient, adhesion, decorative/color effect, etc. See also FIGS. 29A-29B, 30A-30B, 31A-31D, 32, 33, 34, 35A-35B, 36A-36B, 37A-37B and 38A-38B. As indicated schematically in FIGS. 19A-19C, the composite structure CS comprising the cover/skin comprising base layer T and cover layer TX may be produced by application of the cover layer TX as a coating TP from a tool shown as comprising spray head MX. As indicated schematically in FIGS. 21A-21B, 22A-22D and 23A-23B, the composite structure CS comprising the cover comprising base layer T and cover layer TX may be produced by forming of the cover layer TX in a tool shown as comprising a mold MX; as indicated schematically, the substrate SB may be pre-heated to be formed into the structural substrate in the tool shown as oven MX (see FIG. 22A); as indicated schematically, the substrate SB may be compression formed and/or molded into a structural substrate in the tool shown as mold MX (see FIG. 22B); the cover comprising base layer T and cover layer TX may be formed in the tool shown as mold MX such as by injection molding, compression molding, compression forming, etc. (see FIG. 23A); the cover comprising base layer T and cover layer TX may be formed on the substrate SB in the tool shown as mold MX such as by injection molding, compression molding, etc. (see FIG. 23A); surface effect of the cover comprising base layer T and cover layer TX may be formed and/or imparted by the tool shown as mold MX (e.g. shape, form, texture, hardness/softness, color, etc.). See FIGS. 1B, 2, 3, 4, 5, 6, 7A-7B, 8, 9, 10, 11, 12, 16A, 22D and 23B. As indicated schematically in FIGS. 18A-18E, the cover of the composite structure may comprise an intermediate/barrier layer TN such as a layer/membrane at an interface of the base layer T with the cover layer TX and/or at an interface of the base layer T with the substrate SB.

According to an exemplary embodiment as indicated schematically in FIGS. 13A-13D, 14A-14D, 15A-15D, 16A-16B, 17A-17B, 18A-18E and 20, a component C for a vehicle interior may comprise a composite structure CS shown as a multilayer material comprising a substrate/base SB shown as a structural substrate such as a lightweight skeleton/structure and a cover comprises a base layer T such as a resilient/soft layer and a cover layer TX such as a skin layer; the base layer T may be provided between the structural substrate SB and the cover layer TX; the base layer T may be formed by molding such as injection molding and/or as a layer, etc.; the cover layer TX may be formed by molding such as injection molding and/or as a film/coating, etc.; a layer/membrane such as a barrier layer TN may be provided between the base layer T and the cover layer TX of the cover; a layer/membrane such as an intermediate layer TN may be provided between the substrate SB and the base layer T of the cover; the structural substrate SB may be provided as a base/structure such as a panel such as a fiber panel and/or formed by molding such as injection molding, foam injection molding, and or as a multi-layer substrate with layer SBa and SBb, etc.; the composite structure may comprise structure such a formed structure for the base layer of the cover and/or for the substrate.

According to an exemplary embodiment as indicated schematically, a component may comprise a composite structure comprising a cover comprising a cover material such as a skin material; the cover may comprises a base layer such as a skin layer formed from a material comprising a thermoplastic polyester elastomer by an injection molding process; and a coating on a surface of the skin layer; the base layer such as the skin layer may comprise a soft foam layer and a layer such as an intermediate layer such as a self-junction skin layer located on both sides of the base layer such as the soft foam layer. A vehicle trim may comprise the composite structure comprising the skin material; a vehicle may comprise the vehicle trim.

A composite structure such as a skin material for a component for a vehicle interior may comprise a skin layer; the skin layer may be formed from a material comprising a thermoplastic polyester elastomer by an injection molding process; the skin layer may comprise a coating on a surface of the skin layer; the skin layer may comprise a soft foam layer and a self-junction skin layer located on two sides of the soft foam layer; the chain segment of the thermoplastic polyester elastomer may comprise an active functional group comprising a hydroxyl group, a carboxyl group, an amine group, or a combination; the thermoplastic polyester elastomer may comprise a hard segment and a soft segment; the hard segment of the thermoplastic polyester elastomer may comprise poly (butylene terephthalate), poly(ethylene terephthalate), poly (trimethylene terephthalate), poly (trimethylene terephthalate)/poly (butylene terephthalate), poly (2,6-naphthalate), poly (trimethylene terephthalate), poly(ethylene terephthalate)/polybutylene terephthalate copolymers, poly (dimethyl terephthalate/m-xylylene)/1,4-butanediol copolymers, poly (2,5-furan dicarboxylate), poly(2,5-furandicarboxylic acid) propylene glycol ester, poly (2,5-furandicarboxylate), poly(2,5-furan dicarboxylate), or a combination; the method may comprise polybutylene terephthalate, poly(2,5-furandicarboxylate), or a combination; the soft segment of the thermoplastic polyester elastomer may comprise polyethylene glycol, polybutylene glycol, polycaprolactone, polyethylene glycol, fatty acid dimer diol, polytetramethylene ether, ethylene oxide-propylene oxide copolymer bisphenol A ether, polypropylene glycol, polylactide, polyglycolide, or a combination; preferably, polyethylene glycol, polycaprolactone, polytetramethylene ether, or a combination; the material for forming the skin layer may comprise a compatible resin, a plasticizer, or a combination; the compatible resin may comprise polybutylene terephthalate, polyethylene terephthalate, polyamide, acrylonitrile-butadiene-styrene copolymer, polycarbonate, epoxy resin, or a combination; the plasticizer may comprise an ortho-benzoate compound, a phthalic acid compound, an aliphatic dibasic acid compound, an epoxy ester compound, a phosphate ester compound, or a combination; the material for forming the skin layer may have a melt index of 50-400 g/10 min, preferably 200-300 g/10 min, measured at 220 deg C. and 2.16 kg; and/or the density of the material forming the skin layer may be 0.95-1.15 g/cm, preferably 1.05-1.15 g/cm; the coating may be formed from a coating system; the coating system may comprise a film-forming agent and a crosslinking agent; the film-forming agent may comprise polyacrylate, polyurethane, or a combination; the crosslinking agent may comprise aziridine, isocyanate, carbodiimide, or a combination; the coating system may comprise a solvent, a feel agent, a leveling agent, an anti-fouling agent, or a combination; the solvent may comprise water, ethanol, isopropanol, or a combination; the hand-feel agent may comprise a silane-based auxiliary agent; the leveling agent may comprise polyacrylic acid, methyl carboxylic acid methyl cellulose, or a combination; the anti-fouling agent may comprise an acrylic fluoropolymer, an organosiloxane polymer, or a combination; the solid content of the coating system may be 10-30 wt percent; the coating may have a thickness of 5 to 18 μm and/or the density of the coating may be 0.7-1.3 g/cm, preferably 0.9-1.1 g/cm; the coating may be formed by a spray coating process; the skin material has may comprise a texture; the thickness of the skin layer may be 1.5-2.5 mm, the elongation at break of the coating may be 100-200 percent; the thickness of the skin layer may be 1.2-1.5 mm, the elongation at break of the coating may be 200-300 percent; the thickness of the skin layer may be 0.3-1.2 mm, the elongation at break of the coating may be 300-500 percent; the skin material may comprise one or more of: a water droplet angle of the skin material at room temperature above 100 deg C, preferably 110 deg C. or more and/or skin material comprising a gloss change rate of 20 percent or less, preferably 15 percent or less according to ISO 5470-1-2016 and/or peel grade of the skin material according to ISO 2409:1992 may be Grade 1 or Grade 0 and/or the maximum acceleration measured by the skin material according to the standard VDA 230-206 Stick-slip test standard in the German automotive industry may be 0.05-1.50; preferably 0.08-1.00 and/or the maximum dynamic friction coefficient measured by the skin material according to the standard VDA 230-206 Stick-slip test standard in the German automotive industry may be 0.2-1.2, preferably 0.3-1.0 and/or the maximum static friction coefficient measured by the skin material according to the standard VDA 230-206 Stick-slip test standard in the German automotive industry may be 0.2-1.50, preferably 0.3-1.2; the vehicle trim piece may comprise an instrument panel, a door panel, a center console, an armrest or a seat; the vehicle may comprise an automobile, an aircraft, a ship, a cycle, an electric vehicle, a train, a subway or a light rail.

As indicated schematically, the composite structure comprising a cover comprising a skin material may comprise a skin layer and a coating on a surface of the skin layer. In the present disclosure, from the two angles of chemical composition and physical structure, the skin layer and the coating in the skin material are reasonably designed, so that the skin material has the characteristics of excellent hand feeling, scratch resistance, stain resistance, weather resistance, etc. and the adhesion force between the coating and the skin layer is strong that has a good bonding effect and the coating is not easy to fall off and the service life may be prolonged. The preparation process of the skin material according to an exemplary embodiment is simple and environmentally friendly and the application scenario is enhanced (e.g. luxury/rich appeal, etc.) and may enhance market application prospects/opportunity. As indicated schematically, the composite structure comprising a cover comprising a skin material may be used in a vehicle and may be used for coating a vehicle trim piece to improve the use feeling of the vehicle trim piece. The skin layer acts as a substrate, acting as a body structure of the skin material. Suitable skin layers may impart desirable properties to the product, such as suitable color rendering, good tactile feel, excellent mechanical strength and weather resistance, etc. As indicated schematically, the composite structure comprising a cover comprising a skin material may may be formed by an injection molding process from a material comprising a thermoplastic polyester elastomer. Thermoplastic polyester elastomers have excellent properties such as excellent mechanical strength, good tear resistance, chemical corrosion resistance, ease of processing, excellent resilience, etc. suitable for coating materials for automotive interior components. The skin material according to an exemplary embodiment is used in a vehicle trim piece; coating a vehicle interior trim piece and may provide a user with a soft touch feeling close to or similar to a dermal hand feeling, thereby improving the user experience.

As indicated schematically, the composite structure comprising a cover comprising a skin material may improve the soft tactile sensation of the skin material, increasing the cushioning property, etc.; the skin layer may be foamed to form a middle soft foam layer and the two sides are sandwich structures with self-junctions. According to an exemplary embodiment, the skin layer comprises: a soft foam layer and a formed layer shown as self-junction skin layer located on both sides of the soft foam layer.

As indicated schematically, the composite structure comprising a cover comprising a skin material may comprise a method of production with manufacturing process and assembly process; a foaming process may employ chemical foaming, such as mixing a blowing agent into the raw material forming the skin layer, closing the mold, or opening the mold. Blowing agents may employ blowing agents commonly employed in the field of polymer processing. The foaming process may also use physical foaming; mixing a supercritical fluid into the raw material forming the skin layer to achieve the physical foaming process. The use of the foaming agent may be reduced by physical foaming, the process route is more environmentally friendly and the deterioration of product performance (such as bad odor, etc.) may also be avoided due to possible chemical solvent residues in chemical foaming.

As indicated schematically, the composite structure comprising a cover comprising a skin material may comprise a skin layer prepared by using an injection molding process. According to an exemplary embodiment, the material forming the skin layer is added to the injection molding machine, the material is heated and dispersed in the screw rod of the injection molding machine and then injected into the mold cavity at a high speed and after the mold cavity is filled, the molding product is cooled to obtain a molded product.

According to an exemplary embodiment, by the injection molding process a particular styling or texture may be obtained conveniently that is advantageous for products having styling or texturing requirements. According to an exemplary embodiment, by providing the texture of the inner wall of the mold cavity, after the material melt fills the mold cavity, the texture of the surface of the material melt may be replicated on the inner wall of the mold cavity, so that the textures are replicated on the surface of the skin layer to obtain the textured skin material. According to an exemplary embodiment, by designing the mold cavity, a correspondingly shaped skin material may be obtained.

According to an exemplary embodiment, the thickness of the skin layer is usually 0.3-2.5 mm. The excessively thin skin layer cannot form a good protective effect on the trim and the strength of the material may be too low and thus is easily damaged by external factors (such as friction, weathering, lighting, etc.), resulting in loss of functionality and esthetics. In addition to the rise of the cost of the component/product, the excessively thick skin layer may also cause a decrease in esthetics; for an interior trim with a fine structure, a too thick skin layer may not achieve a good coating effect.

As indicated schematically, the composite structure comprising a cover comprising a skin material may comprise preparation of a desired skin layer (with a desired thickness range, optionally with a texture structure) by means of an injection molding process; adjustment may be provided for the composition of the material forming the skin layer, so that the material is suitable for use.

According to an exemplary embodiment, the material forming the skin layer has a suitable physical and chemical parameter range, so as to ensure the feasibility of preparing during the injection molding process. According to an exemplary embodiment, the performance of the article may also be improved to meet the performance requirements of the automobile industry (such as strength, wear resistance, etc.).

According to an exemplary embodiment, the material forming the skin layer has a melt index of 50-400 g/10 min, preferably 200-300 g/10 min, for example 200 g/10 min, 250 g/10 min, 300 g/10 min, etc. measured at 220 deg C. and 2.16 kg. The melt index may be measured according to ISO 1133, at 220 deg C. and 2.16 kg. The melt index is too low and for the desired thickness of the skin material, the fluidity of the material melt is too poor, so that a narrower mold cavity cannot be fully filled. When the skin material has a texture or a three-dimensional modeling requirement, a material with an excessively low melting index cannot be well filled with a detail position. A suitable melt index may meet the requirements for the achievable thickness, texturing, or stereographic modeling of the material, the achievable radius R of the achievable curved filet of the article is 1 mm and the limit radius R is 0.5 mm.

According to an exemplary embodiment, the material forming the skin layer has a density of 0.95-1.15 g/cm, preferably 1.05-1.15 g/cm, for example 0.95 g/cm, 1.00 g/cm, 1.05 g/cm, 1.10 g/cm, 1.15 g/cm, etc. The density of the material may be measured according to ISO 1133. Suitable material densities help to improve the properties of the skin material, for example to have suitable physical characteristics. Suitable parameter characteristics of the material help to obtain the skin material with the desired properties such that the skin material meets the performance requirements of the automotive industry for the interior trim piece.

According to an exemplary embodiment, the material forming the skin layer has a Shore A hardness of 60-80, preferably 65-75, such as 60, 65, 70, 75, 80, etc. The Shore A hardness of the material may be determined according to ISO 868 15 s.

According to an exemplary embodiment, the material forming the skin layer has a tensile strength of 3-10 Mpa, preferably 5-8 Mpa, such as 3 Mpa, 4 Mpa, 5 Mpa, 6 Mpa, 7 Mpa, 8 Mpa, 9 Mpa, 10 Mpa, etc. The tensile strength of the material may be measured according to ISO 37 or ISO 527, for example by ISO 527-1.

According to an exemplary embodiment, the material forming the skin layer has an elongation at break of 100 percent to 800 percent, such as 100 percent, 150 percent, 200 percent, 250 percent, 300 percent, 350 percent, 400 percent, 500 percent, 600 percent, 700 percent, 800 percent, etc. The elongation at break of the material may be measured according to ISO 37 or ISO 527; as measured by ISO 527-1.

According to an exemplary embodiment, the material forming the skin layer has a tear strength of 20-60 kN/m, preferably 30-50 kN/m, such as 20 kN/m, 30 kN/m, 40 kN/m, 42 kN/m, 45 kN/m, 48 kN/m, 50 kN/m, 55 kN/m, 60 kN/m, etc. The tear strength of the material may be measured according to ISO 34.

As indicated schematically, the composite structure comprising a cover comprising a skin material may provide a desired skin layer obtained by adjusting the chemical structure of the thermoplastic polyester elastomer such that the material forming the skin layer has the desired properties. Suitable soft segments and hard segments in the thermoplastic polyester elastomer help to adjust the material properties. The hard segment of the thermoplastic polyester elastomer may comprise: Polybutylene terephthalate, polyethylene terephthalate, poly (trimethylene terephthalate), poly(ethylene terephthalate)-1,4-dimethylene cyclohexane, poly(2,6-naphthalate), xylene terephthalate, polyethylene terephthalate/polybutylene terephthalate copolymers, poly (dimethyl terephthalate/isophthalate/1,4-butanediol) copolymers, poly(2,5-furan dicarboxylate), poly(2,5-furandicarboxylic acid) propylene glycol ester, poly(2,5-furandicarboxylate), poly (2,5-furandicolinate), or a combination. As indicated schematically, the hard segment of the thermoplastic polyester elastomer may comprise polybutylene terephthalate, poly2,5-furandicarboxylic acid butylene glycol ester, or a combination. The soft segment of the thermoplastic polyester elastomer may comprise polyethylene glycol, polybutylene glycol, polycaprolactone, polyethylene glycol, fatty acid dimer diol, polytetramethylene ether, ethylene oxide-propylene oxide copolymer bisphenol A ether, polypropylene glycol, polylactide, polyglycolide, or a combination. As indicated schematically, the soft segment of the thermoplastic polyester elastomer may comprise polyethylene glycol, polycaprolactone, polytetramethylene ether, or a combination. The proportion of soft segments and hard segments in the thermoplastic polyester elastomer may be within a suitable range to impart good performance to the formed skin layer. In the thermoplastic polyester elastomer, a molar ratio of the hard segment to the entire copolyester elastomer ranges from 25 percent to 60 percent, preferably 30 percent to 40 percent; and the soft section accounts for 40 percent to 75 percent, preferably 60 percent to 70 percent, of the total copolyester elastomer.

As indicated schematically, a higher molecular weight thermoplastic polyester elastomer is preferably used to form the skin layer that facilitates optimization of the performance of the skin layer. The thermoplastic polyester elastomer may have a molecular weight of 20000 to 40000, preferably 30000 to 40000, preferably 33000 to 38000. The thermoplastic polyester elastomer may be present in an amount of 20-97 wt percent, preferably 30-80 wt percent, preferably 60-90 wt percent, such as 20 wt percent, 30 wt percent, 40 wt percent, 50 wt percent, 60 wt percent, 65 wt percent, 70 wt percent, 75 wt percent, 77 wt percent, 80 wt percent, 84 wt percent, 85 wt percent, 90 wt percent, 95 wt percent, 97 wt percent, etc. based on the total weight of the material forming the skin layer.

As indicated schematically, the composite structure comprising a cover comprising a skin material may comprise forming the skin layer to comprise other components to adjust properties including, but not limited to compatible resins, lubricants, plasticizers, fillers, antioxidants, colorants, anti-ultraviolet agents, etc. Suitable compatible resins may form a good combined effect with the thermoplastic polyester elastomer that helps to improve the fluidity of the melt of the material and is also beneficial to the optimization of the material properties. The compatible resin may be polybutylene terephthalate, polyethylene terephthalate, polyamide, acrylonitrile-butadiene-styrene copolymer, polycarbonate, epoxy, or a combination, preferably polybutylene terephthalate or polyamide. The content of the compatible resin may be 3-70 wt percent, preferably 3-50 wt percent, more preferably 3-10 wt percent, such as 3 wt percent, 4 wt percent, 5 wt percent, 6 wt percent, 7 wt percent, 8 wt percent, 9 wt percent, 10 wt percent, 15 wt percent, 20 wt percent, 40 wt percent, 50 wt percent, 70 wt percent, etc. based on the total weight of the material forming the skin layer. The compatible resin may have a weight average molecular weight of 8000 to 12000, preferably 8500 to 11000, preferably 9000 to 10500, in particular 10000 Daltons. The compatible resin may have a viscosity measured according to ISO 307 of 82±15 ml/g, 90±15 ml/g, 100±15 ml/g, 115±15 ml/g, 118±15 ml/g, 120±15 ml/g, in particular 105±15 ml/g. The compatible resin may have a tensile strength measured according to ISO 527-1 of 31 to 46 MPa, preferably 35 to 43 MPa, preferably 38 to 41 MPa, in particular 40 MPa. The elongation at break measured according to ISO 527-1 may be 35 to 56 percent, preferably 45 to 53 percent, preferably 48 to 51 percent, in particular >50 percent. The compatible resin may have a Shore D hardness of 50 to 80, preferably 55 to 70, preferably 62 to 68, in particular 65, measured according to ISO 868 15 s.

As indicated schematically, the composite structure comprising a cover comprising a skin material may comprise a plasticizer added to the material forming the skin layer to improve the fluidity and softness of the material. The plasticizer may include: an ortho-benzoate compound, a phthalic acid compound, an aliphatic dibasic acid compound, an epoxy ester compound, a phosphate ester compound, or a combination. Examples of ortho-benzoate compounds include: octyl phthalate (DOP), di-ester phthalate (DBP), diisobutyl phthalate (DIDP). Examples of trimellitic compounds include trioctyl trimellitic acid. Examples of aliphatic dibasic acid compounds include dioctyl adipate (DOA), dioctyl azelate (DOZ), dioctyl malonate (DOS) and the like. The plasticizer may be present in an amount of 3-15 wt percent, preferably 6-12 wt percent, such as 3 wt percent, 4 wt percent, 5 wt percent, 6 wt percent, 7 wt percent, 8 wt percent, 9 wt percent, 10 wt percent, 11 wt percent, 12 wt percent, 13 wt percent, 14 wt percent, 15 wt percent, etc. based on the total weight of the material forming the skin layer.

As indicated schematically, the composite structure comprising a cover comprising a skin material may comprise material forming the skin layer comprising conventional additives in the art, including but not limited to lubricants, plasticizers, fillers, antioxidants, anti-ultraviolet agents, colorants, etc. As indicated schematically, the addition of the additive is used to properly adjust the properties of the system and the amount of the additive generally should not be too high and may be added in an appropriate amount according to actual requirements. Suitable lubricants may include silicone, polyethylene wax, calcium stearate, or a combination. Suitable fillers may be selected from talc, white carbon black, diatomaceous earth, bentonite, calcium carbonate, calcium oxide, magnesium carbonate, barium sulfate, light calcium carbonate, nano zinc oxide, calcium sulfate anhydrous, calcium hydroxide, clay, ceramic microspheres, kaolin, magnesium oxide, magnesium hydroxide, calcium oxide, aluminum oxide, aluminum hydroxide, perlite, wollastonite, hydrotalcite, zinc sulfide and combinations. The antioxidant may be selected from a hindered phenolic antioxidant, a hindered amine antioxidant, an aromatic secondary amine antioxidant, a thioester antioxidant, a phosphite antioxidant, a phosphite antioxidant, a thioether antioxidant, a nitrogen-resistant antioxidant and a combination.

As indicated schematically, the composite structure comprising a cover comprising a skin material may comprise an anti-ultraviolet agent selected from the group consisting of oxalanilide, benzophenone, benzotriazole, benzotriazines, salicylates, benzophenones, substituted acrylonitrile and combinations. The colorant may be selected from the group consisting of benzimidazolone, DPP red, quinacridone, phthalazine, anthraquinone, carbon black, titanium white powder, iron oxide series toner, lead chromate series toner, organic toner such as phthalocyanine blue powder or group cyan powder, inorganic toner such as iron oxide red, iron oxide black or chromium green, composite toner such as iron oxide orange or sea blue powder and combinations.

According to an exemplary embodiment, the skin layer is formed by an injection molding process of a material comprising a thermoplastic polyester elastomer and a skin layer having properties such as excellent soft touch and mechanical strength may be obtained by adjusting the chemical composition and physical properties of the material forming the skin layer.

According to an exemplary embodiment, as a soft rubber material, the thermoplastic polyester elastomer is used as a vehicle interior decoration material. Although the present application has the advantages (such as good mechanical strength, good tear resistance, chemical corrosion resistance, easy processing, excellent resilience, good soft touch, etc.), due to its own characteristics determined by the chemical structure of the thermoplastic polyester elastomer, the product has poor performance on the surface feel and has poor scratch resistance, stain resistance and the like. Although these problems may be improved to some extent by modifying the material itself (e.g. adjusting the chemical structure of the thermoplastic polyester elastomer, adding a suitable compatible resin or other additive), a satisfactory degree cannot be achieved. In order to enable the skin material to maintain the advantages of using the thermoplastic polyester elastomer material; the target may be achieved by loading a special coating on the skin layer.

According to an exemplary embodiment as shown schematically, the coating may improve the properties of the skin material; the adhesion between the coating and the skin layer is one of the important factors affecting the period of use of the skin material. The stronger the adhesion between the coating and the skin layer, the coating is not easy to fall off that is beneficial to prolonging the use cycle and the product is more environmentally friendly.

As indicated schematically, the composite structure comprising a cover comprising a skin material may comprise bonding performance between the coating and the skin layer, the chain segment of the thermoplastic polyester elastomer comprises an active functional group and active functional groups may form a strong chemical bond connection with the components contained in the coating; increasing the adhesion force between the skin layer and the coating. According to an exemplary embodiment, the active functional group in the segment of the thermoplastic polyester elastomer may also form a strong chemical bond with the compatible resin and therefore, the mechanical properties (such as tear resistance, tensile strength, etc.) of the prepared skin layer are optimized.

According to an exemplary embodiment, the active functional group refers to a functional group that may chemically react with components in the coating. As indicated schematically, the chemical reactions may be accomplished in the conventional preparation process or preparation conditions of the skin material, preferably by components contained in the skin layer and the coating without the addition of additional components to complete the chemical reaction; the advantage that good adhesion of the coating and the skin layer is achieved during the preparation of the skin material without introducing additional components or adding additional processes, reducing production costs and increasing production efficiency.

According to an exemplary embodiment, in the coating material a suitable crosslinking agent is selected and in addition to helping to improve the properties of the coating, the crosslinking agent may also complete a chemical reaction with the active functional group in the chain segment of the thermoplastic polyester elastomer to form a strong chemical bond; improving the bonding effect between the coating and the skin layer. Preferred active functional groups in the segments of the thermoplastic polyester elastomer include hydroxyl, carboxyl, amine groups, or combinations.

As indicated schematically, the composite structure comprising a cover comprising a skin material may comprise bonding formed between the injection-molded skin layer and the coating to form a two-layer structure. The injection molded skin layer does not need to perform additional surface polarity treatment or spray coating the bottom coating material that greatly simplifies the process flow and is more environmentally friendly.

According to an exemplary embodiment, a suitable film/layer and/or coating is coated on the surface of the skin layer to impart a smooth feel to the skin material and excellent scratch resistance, abrasion resistance, lighting resistance, yellowing resistance and other properties are provided prolonging the service life of the component/product. The layer/coating may be located on one or both sides of the skin layer. For cost considerations, the coating may be provided only on one side surface of the skin layer and in actual use, the coating is located on the side of the skin layer close to the user, the user may contact or see the skin layer of the coating, the user may provide good use experience to the user while resisting external adverse factors (such as light, weathering, scraping, etc.). The use of aqueous coating systems to form coatings is of great significance for environmental protection and health considerations. According to an exemplary embodiment, an aqueous coating system with good performance is obtained by selecting a suitable coating component to form the coating according to an exemplary embodiment.

As indicated schematically, the composite structure comprising a cover comprising a skin material may comprise suitable film-forming agents in the coating system help to increase the matching of the coating and the skin layer, imparting excellent feel and performance to the skin material. Preferred film formers in the present application include, but are not limited to, polyacrylates, polyurethanes, or combinations. The film-forming agent may be present in an amount of 30-45 wt percent, such as about 30 wt percent, 31.3 wt percent, 32 wt percent, 34 wt percent, 36 wt percent, 38 wt percent, 38.7 wt percent, 40 wt percent, 42 wt percent, 45 wt percent, etc. based on the total weight of the coating system. A suitable crosslinking agent may improve the self-property of the coating and form a good bonding effect with the skin layer and a suitable active group in the crosslinking agent may form a stable chemical bond connection with the active functional group on the thermoplastic polyester elastomer molecular chain segment. Preferred cross-linking agents in the present application include, but are not limited to, aziridine, isocyanate, carbodiimide, or a combination. Different from the conventional means that the crosslinking agent is only used to provide the cross-linking effect of the coating itself, the crosslinking agent further provides sufficient chemical bonding connection between the coating and the skin layer. As indicated schematically, the excellent effect may be achieved by using a suitable content of a cross-linking agent. The crosslinking agent may be present in an amount of 3-15 wt percent, such as about 3 wt percent, 4 wt percent, 5 wt percent, 6 wt percent, 8 wt percent, 10 wt percent, 12 wt percent, 14 wt percent, 15 wt percent, etc. based on the total weight of the coating system. The content of the crosslinking agent is too low and the coating may decrease in its own performance due to insufficient crosslinking degree and is also not conducive to the bonding strength between the coating and the skin layer; the content of the crosslinking agent is too high that may cause the residual of the crosslinking agent to increase to an undesirable level; too high or too low crosslinking agent content is not conducive to obtaining the desired skin material.

According to an exemplary embodiment as indicated schematically, the composite structure comprising a cover comprising a skin material may comprise a coating system comprising a film-forming agent as a polyacrylic resin emulsion and the crosslinking agent as aziridine. As indicated schematically, the composite structure comprising a cover comprising a skin material may comprise a coating system with the film-forming agent as a polyurethane resin emulsion and the crosslinking agent as an isocyanate. In the coating system, the solvent is used for dispersing solid components. The preferred solvent in the present application is an aqueous solvent to achieve environmental protection and health requirements. The preferred solvent is water or an alcohol solvent, such as water, ethanol, isopropanol, etc. These solvents may enable a good and stable dispersion of the preferred film-forming agent, crosslinking agent and other possible components in which a good and stable dispersion is formed.

As indicated schematically, the composite structure comprising a cover comprising a skin material may improve the feel and weather resistance of the skin material; an appropriate amount of other additives may also be added to the coating, including, but not limited to, a feel agent, a leveling agent, an anti-fouling agent and the like. The feel agent may further optimize the feel of the coating. According to an exemplary embodiment, the feel agent comprises a silane-based aid.

The leveling agent has a coating film that causes the coating to form a flat, smooth, uniform coating during the drying of the film-forming process. The surface tension of the coating liquid may be effectively reduced and the leveling property and uniformity may be improved. Suitable feel agents include polyacrylic acid, methyl carboxylic acid methyl cellulose, or combinations. The anti-fouling agent may improve the anti-fouling performance of the component/product. Suitable anti-fouling agents include acrylic fluoropolymers, organosiloxane polymers, or combinations.

As indicated schematically, the composite structure comprising a cover comprising a skin material may in the coating system comprise other additives, such as an antioxidant, a defoaming agent, a color paste, an anti-UV additive, a filler, etc. may also be included to improve the performance of the coating. The thickness of a suitable coating may improve the performance of the component/product. The coating thickness may be 5-18 μm, such as 5 μm, 6 μm, 8 μm, 10 μm, 12 μm, 14 μm, 16 μm, 18 μm, etc. The coating is too thin and is not conducive to the protective effect and performance optimization effect on the skin layer; and the coating is too thick that may also cause the possibility of falling off of the coating. A suitable coating density may provide the coating with the desired effect. The density of the coating is 0.7-1.3 g/cm, preferably 0.9-1.1 g/cm and the density of the coating refers to the dry film density, the density of the coating formed after the coating system is cured and dried. If the density of the coating is too low, the smooth feel of the skin layer is improved and the weather resistance is not significant; the density of the coating is too high that may cause an increase in hardness, resulting in a decrease in the soft touch. The coating density may be adjusted by a suitable solid content. The solid content is the mass percentage of the remaining part of the coating after drying under specified conditions. The solid content in the coating system may be 10-30 wt percent.

According to an exemplary embodiment, in combination with the combination of components and contents in the coating system, the obtained coating may significantly improve the performance of the skin layer (for example, reduce surface sticking feeling, improve stain resistance, provide a smooth feel, improve weather resistance, etc.) and may also form an excellent bonding effect with the skin layer.

As indicated schematically, the composite structure comprising a cover comprising a skin material may comprise thickness of the skin layer and the elongation at break of the coating with specific relationships to further optimize product performance. In order to improve the soft tactile sensation to appropriately reduce the thickness of the skin layer, the reduction in thickness of the skin layer may lead to increased stretching during actual use. Increasing the elongation at break of the coating helps to ensure uniform stress between the coating and the skin layer, but the elongation at break of the coating is too high and the proportion of soft segments in the corresponding coating material will increase that is not conducive to the physical properties of the coating (such as abrasion resistance, stain resistance, chemical solvent resistance, etc.). According to an exemplary embodiment, the elongation at break of the coating and the thickness of the skin layer match each other and for applicable skin layer thicknesses in different applications, a suitable coating elongation at break is selected to provide good stress uniformity between the coating and the skin layer and at the same time balance other physical properties of the coating. The skin layer and the coating may satisfy the following relationship: when the thickness of the skin layer is 1.5-2.5 mm, the elongation at break of the coating is 100-200 percent; when the thickness of the skin layer is 1.2-1.5 mm, the elongation at break of the coating is 200-300 percent; and when the thickness of the skin layer is 0.3-1.2 mm, the elongation at break of the coating is 300-500 percent. As indicated schematically, the composite structure comprising a cover comprising a skin material may be configured to enhance stain resistance. The anti-fouling properties may be evaluated by conventional means in the art; the water droplet angle test may be used to determine the stain resistance of the surface through the surface-to-water immersion characteristic. The larger the water droplet angle, the stronger the ability to resist liquid stains on the surface. The water droplet angle of the skin material at room temperature may be above 100 deg C, preferably 110 deg C. or more; about 100 deg C, 105 deg C, 110 deg C, 111 deg C, 112 deg C, 113 deg C, 115 deg C, 120 deg C, 130 deg C, etc.

As indicated schematically, the composite structure comprising a cover comprising a skin material may enhance bonding property between the coating and the injection molded skin layer; testing may comprise a scribing test, a Taber friction test, an alcohol resistance friction, etc. The bonding strength between the coating and the skin layer may be evaluated according to the gloss change condition of the sample before and after testing by using a Taber friction test. The skin material has a gloss change rate of 20 percent or less, preferably 15 percent or less according to ISO 5470-1-2016. Gloss Rate=(Sample Gloss Before Sample Gloss Test Before Taber Friction Test)/Gloss of Sample Before Taber Friction Test. The peel grade of the skin material according to ISO 2409:1992 is Grade 1 or Grade 0. The skin material has a maximum acceleration of 0.05-1.50, preferably 0.08-1.00; about 0.05, 0.06, 0.07, 0.08, 0.0882, 0.0891, 0.0835, 0.0803, 0.09, 0.1, 0.2, 0.3, 0.4, 0.5, 1.0, 1.5, etc. measured according to the standard VDA 230-206 Stick-slip stick testing standard in the German automotive industry. In the skin material, the maximum dynamic friction coefficient measured according to the standard VDA 230-206 Stick-slip test standard in the German automotive industry is 0.2-1.2, preferably 0.3-1.0; about 0.2, 0.3, 0.3701, 0.3662, 0.3447, 0.4, 0.4231, 0.5, 0.6, 0.7, 0.8, 0.9, 1.0, 1.1, 1.2, etc. In the skin material, the maximum static friction coefficient measured according to the standard VDA 230-206 Stick-slip test standard in the German automotive industry is 0.2-1.50, preferably 0.3-1.2; about 0.2, 0.3, 0.3905, 0.4, 0.4252, 0.4109, 0.4357, 0.5, 0.6, 0.7, 0.8, 0.9, 1.0, 1.1, 1.2, 1.3, 1.4, 1.5, etc. The skin material may have a texture for requirements such as esthetics and hand feeling. The texture of the skin material may be achieved during injection molding of the skin layer.

As indicated schematically, the composite structure comprising a cover comprising a skin material may comprise a coating system to form a layer/coating by a spraying process. The spraying process has particular advantages for the skin material with texture, since the spraying process may well cover the fine structure of the texture. The coating system may be sprayed on the surface of the skin layer and then cured to obtain the coating. Before spraying, the surface of the skin layer may be cleaned to increase the bonding effect of the coating and the skin layer.

As indicated schematically, the composite structure comprising a cover comprising a skin material may comprise a texture in the skin layer; the adhesion performance requirements for the coating and the skin layer are improved; the protruding position of the texture is easier to wear. As indicated schematically, excellent adhesion between the coating and the skin layer may improve the service life and performance of the skin material with texture.

As indicated schematically, the composite structure comprising a cover comprising a skin material may provide for a component such as vehicle trim with a substrate such as a carrier as structural substrate. As indicated schematically, the composite structure comprising a cover comprising a skin material may be configured to provide a quality as the surface effect (e.g. rich, luxury, etc. appearance as visual effect) as used as a coating material for a vehicle trim; the cover may be used in the fields of instrument panels, door panels, center consoles, armrests, seats, etc. The coating of the skin material is located on the side of the skin layer close to the user; the user may contact or see the coated skin layer. According to an exemplary embodiment, the skin material according to an exemplary embodiment is used as the cladding material of the vehicle interior trim.

According to an exemplary embodiment, a material containing a thermoplastic polyester elastomer is made into a skin layer by means of an injection molding process that has good soft touch and mechanical properties. By loading a suitable coating on the skin layer, the feel and weather resistance of the surface is improved. The skin material obtained has advantages such as excellent hand feeling, scratch resistance, stain resistance, weather resistance, etc. by reasonably designing the materials and physical properties of the skin layer and the coating and the adhesion force between the coating and the skin layer is strong and has a good bonding effect.

As indicated schematically, the composite structure comprising a cover comprising a skin material may comprise a preparation process of the skin material according to an exemplary embodiment to be relatively simple and environmentally friendly and to provide enhanced market application prospect/opportunity. As indicated schematically according to an exemplary embodiment, samples/examples of including comparative examples were prepared according to a process: Preparation of the skin layer: drying the thermoplastic polyester elastomer and the compatible resin in the material forming the skin layer, adding the remaining additives uniformly, extruding and granulating through twin screws, stirring and mixing and further baking to obtain the raw material particles forming the skin layer. The raw material particles forming the skin layer are added into an injection molding machine and the material is heated and dispersed in the screw rod of the injection molding machine to form a melt and then injected into the mold cavity at a high speed and after the mold cavity is filled, the mold cavity is filled with cooling to obtain an injection molded skin layer. Coating preparation: after the surface of the injection molded skin layer is cleaned, the coating system is sprayed, a uniform coating liquid film is formed on the surface of the injection molded skin layer and then the coating liquid film is cured to obtain the coating.

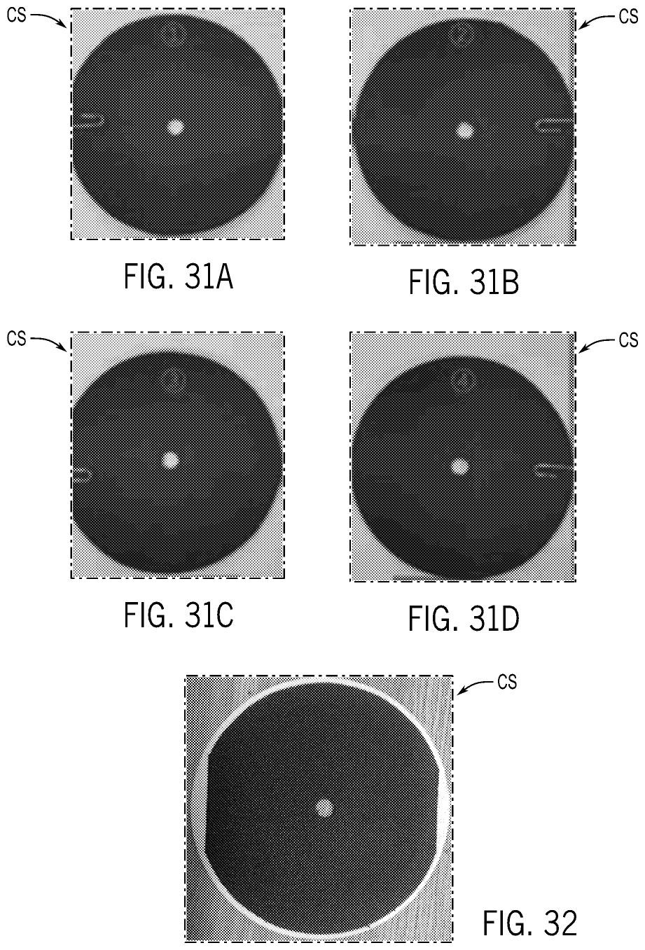

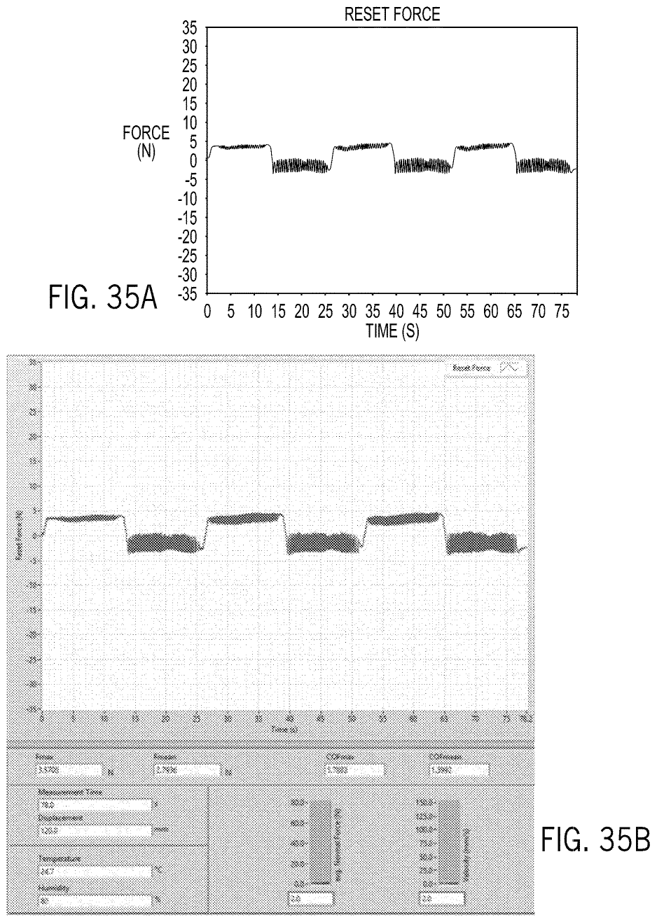

As indicated schematically in FIGS. 29A-29B, 30A-30B, 31A-31D, 32, 33, 34, 35A-35B, 36A-36B, 37A-37B and 38A-38B, test methods were applied to samples/examples of the composite structure with cover such as skin material comprising base layer and cover layer such as film/coating to assess surface effect including performance effect including with use of apparatus (such as representative tool ZF and apparatus MP). See also FIGS. 24A-24B, 25A-25F, 26A-26B, 27A-27B, 28A-28C and TABLES A and 1-8. As indicated schematically, FIGS. 29A-29B and 30A-30B indicate test with a water drop angle test result of a droplet method for a sample in Comparative Example 1 and sample according to Example 1. As indicated schematically, FIGS. 35A-35B, 36A-36B, 37A-37B and 38A-38B, indicate a graph of test results of Taber wear of samples in Examples 1~4 of the present disclosure; test results of Taber wear of samples in Comparative Example 1; test results of the humidity of the sample in Example 1. As indicated schematically, FIGS. 31A-31D, 32, 33 and 34 indicate test apparatus and results including stick-slip test apparatus, stick-slip test result of the sample of Comparative Example 1 and stick-slip test result of the sample of Example 1.

Specific formulas in the samples of the examples are shown in TABLE 1 and TABLES 2 and 3 show the specific formulation of the specific formulation of the material forming the skin layer and the specific formulation of the coating system for the composite structure.

TABLE 1

| | | | Coating | | |
|---|---|---|---|---|---|
| | Cover layer | | | | Elongation |
| Samples | Formulation: | Thickness | Formulation: | Thickness | at break |
| Example 1 | Formulation of | 1.0 mm | Coating | 10 μm | 360 percent |
| | materials that form | | system | | |
| | the cover layer 1 | | formulation A | | |
| Example 2 | Formulation of the | 1.0 mm | Coating | 10 μm | 430 percent |
| | material that forms | | System | | |
| | the cover layer 2 | | Formulation B | | |
| Example 3 | Formulation of | 1.0 mm | Coating | 10 μm | 360 percent |
| | materials that form | | System | | |
| | the cover layer 1 | | Formulation B | | |
| Example 4 | Formulation of the | 1.0 mm | Coating | 25 μm | 430 percent |
| | material that forms | | system | | |
| | the cover layer 2 | | formulation A | | |
| Contrast | Formulation of | 1.0 mm | — | — | — |
| ratio 1 | materials that form | | | | |
| | the cover layer 1 | | | | |

TABLE 2

| | Formulation of materials that | | Formulation of the material that | |
|---|---|---|---|---|
| weight | form the cover layer 1 | | forms the cover layer 2 | |
| Thermoplastic | Thermoplastic polyester | 77 | Thermoplastic polyester | 84 |
| Polyester | elastomer | copies | elastomer | copies |
| Elastomers | DUPONT | | DUPONT | |
| (TPEE) | Hytrel ® G3548 | | Hytrel ® G3548 | |
| Compatible with | ethylene terephthalate | 10 | Nylon 6 | 5 |
| resins | Zhejiang Hengyi HY-C01 | servings | Yuehua, Hunan | servings |
| | | | YH400 | |
| Plasticizers | Trioctyl | 10 | Dioctyl phthalate (DOP) | 8 |
| | metametabenzoate | servings | | servings |
| | (TOTM) | | | |
| Antioxidants | Antioxidant 168 | 0.05 | Antioxidant 168 | 0.05 |
| | | servings | | servings |
| | Antioxidant 1010 | 0.05 | Antioxidant 1010 | 0.05 |
| | | servings | | servings |
| Anti-UV agent | Anti-UV additives 326 | 0.2 | Anti-UV additives 326 | 0.2 |
| | | servings | | servings |
| Lubricant | Silicone masterbatch | 1.2 | Calcium stearate | 1.2 |
| | | servings | | servings |
| Colorants | Black mother | 1.5 | Titanium dioxide | 1.5 |
| | | servings | | servings |

TABLE 3

| weight | Coating system formulation A | | Coating System Formulation B | |
|---|---|---|---|---|
| Film | Water-based polyacrylic | 38.7 | Self-matting water- | 31.3 |
| forming | emulsion | copies | based polyurethane resin | copies |
| agent | | | emulsion | |
| | Huangshan Zhonghao New | | Shanghai Belt | |
| | Materials Co., Ltd. ZH-6014 | | PU7510 | |
| Feel agent | Methylsiloxane emulsion | 10 | Methylsiloxane | 10 |
| | | servings | emulsion | servings |
| | Sloko | | Sloko | |
| | Silok 3300 | | Silok 3300 | |
| Leveling | Methylcellulose carboxylate | 3 | Acrylic emulsion | 3 |
| agent | emulsion | servings | | servings |
| | Celium | | Suzhou Baoxin New | |
| | CMC2200 | | Materials Ltd | |
| | | | Acrylic Emulsion 0725 | |
| Solvents | Water | 40 | Water | 40 |
| | | servings | | servings |
| | | | Isopropyl alcohol | 5 |
| | | | | servings |
| Crosslinkers | Azapropidine | 5 | Polyfunctional group | 10 |
| | | servings | isocyanate | servings |
| | Youen Chemical | | Guangzhou Haoyi New | |
| | SAC-100 | | Materials | |
| | | | Technology Co., Ltd | |
| | | | HF 2828 | |
| Antioxidants | Antioxidant 168 | 0.05 | Antioxidant 168 | 0.05 |
| | | servings | | servings |
| | Antioxidant 1076 | 0.05 | Antioxidant 1010 | 0.05 |
| | | servings | | servings |
| Defoamer | Defoamer | 0.2 | Defoamer | 0.2 |
| | | servings | | servings |
| Colorants | — | — | Pearlescent powder | 0.2 |
| | | | | servings |
| | | | Black pulp | 0.2 |
| | | | | servings |

Stain resistance evaluation: The stain resistance of the sample was evaluated by the water drop angle test of the seat drop method. The sample was placed flat on the sample stage. The needle tip suspends the water droplets, raising the sample stage to bring the sample surface into contact with the suspended water droplets and then removing the sample to complete the transfer of water droplets. The water droplet angle of the water droplets was measured by a water droplet image after water droplet transfer (60±10) seconds.

The stain resistance of the surface is judged by the wetting characteristics of the water droplets on the surface. The larger the water droplet angle, the stronger the ability to resist liquid stains on the surface. The test results are shown in TABLE 4.

TABLE 4

| | Water droplet angle/ | 90 deg C. side |
|---|---|---|
| | deg C. room | discharge water |
| | temperature test | droplets slip down |
| Example 1 | 112 | Roll down |
| Example 2 | 111 | Roll down |
| Example 3 | 113 | Roll down |
| Example 4 | 112 | Roll down |
| Contrast | 89 | Surface adhesion |
| ratio 1 | | |

FIG. 29A shows that the water drop angle for the sample surface of Comparative Example 1 was about 89 deg C. FIG. 29B shows that the water droplets adhere to the skin after the 90 deg C. side of the sample of Comparative Example 1 was placed. FIG. 30A shows that the water drop angle of the surface of the sample of Example 2 was about 111 deg C. FIG. 30B shows that after the 90 deg C. side of the sample of Example 2 is placed, the water droplets roll off and are not adhered to the skin.

Abrasion Resistance Property Evaluation: The wear resistance properties of the skin surface were evaluated according to the Taber Wear Test. The test was performed according to the ISO 5470-1-2016 standard, and the load was 500 g, and the cycle was 500 cycles. The test results are shown in TABLE 5.

TABLE 5

| | Test conditions, | |
|---|---|---|
| | CS10 | |
| | grinding wheel | Test results |
| Example 1 | Load 500 g, | The gloss is maintained at 0.9 |
| | cycle 500 times | and remains unchanged. |
| | | There is no visible wear on the surface |
| Example 2 | Load 500 g, | the gloss decreased from 0.9 to 0.8; |
| | cycle 500 times | There is no visible wear on the surface |
| Example 3 | Load 500 g, | the gloss decreased from 0.9 to 0.8; |
| | cycle 500 times | There is no visible wear on the surface |
| Example 4 | Load 500 g, | The gloss is maintained at 0.9 |
| | cycle 500 times | and remains unchanged. |
| | | There is no visible wear on the surface |
| Contrast | Load 500 g, | the gloss decreased from 1.6 to 1.2; |
| ratio 1 | cycle 500 times | There is obvious wear on the surface |

FIGS. 31A-31D show the surface conditions of the samples of Examples 1-4 after a Taber abrasion test, respectively. FIG. 32 shows the surface status of the sample of Comparative Example 1 after a Taber abrasion test. The samples of Example 1 were scored in different environments according to standard ISO 2409:1992, a series of cuts were performed on the coating, tape bonded and torn off and whether the lattice pattern had a coating drop or delamination was examined. The specific results are shown in TABLE 6. The level of the test results of the scribing test is as follows: Level 0—cutting edge is smooth and does not fall off in one grid; A few coatings fall off at level 1—intersection and the affected area cannot be significantly greater than 5 percent; The two-stage-coating has a coating drop-off at the cut-out or along the edge of the cut-out and has an influence area of 5 percent-15 percent; the 3-stage-coating is partially or completely detached along the cutting edge and the affected cross-cut area is in the range of 15 percent to 35 percent; and 4-stage, falling off along the edge of the edge, some or all of the grids fall off and the affected area is 35 percent-65 percent; and the level of level 5-exfoliation exceeds 4.

TABLE 6

| | | | Test Result / Grade | | | |
|---|---|---|---|---|---|---|
| Test | Specific test | Eligibility | Example | Example | Example | Example |
| Name | conditions | criteria | 1 | 2 | 3 | 4 |
| Initial | Samples are gridded at | ≤ level 1 | 0 | 0 | 0 | 1 |
| grid test | room temperature | | | | | |
| Humidity | The samples were placed | ≤ level 1 | 0 | 0 | 0 | 2 |
| grid test | in an environmental | | | | | |
| | chamber at 38+2 deg C | | | | | |
| | and 100 percent RH for 144 hours | | | | | |
| Thermal | The samples were stored | ≤ level 1 | 0 | 0 | 0 | 3 |
| aging | in an environmental | | | | | |
| grid test | chamber at 105 deg C | | | | | |
| | and after 168 hours, the | | | | | |
| | samples were gridded for testing | | | | | |

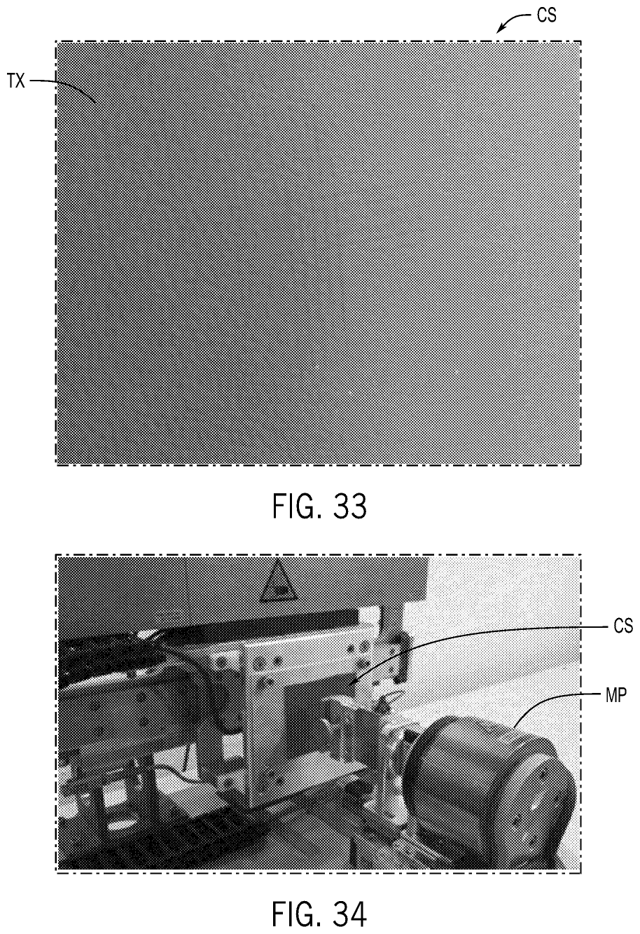

The samples of the embodiments may be tested by scribing. FIG. 33 shows the sample of Example 1 after being subjected to a humidity scribing test and it may be seen from the picture that the cutting edge is smooth and does not have no shedding phenomenon. The coating thickness in Example 4 was 25 μm, the relative deviation was relatively thick and after the environment was stored, there was an obvious coating drop. Qualitative Evaluation: The smoothness, softness, tactile heating and filament smoothness of the sample were artificially rated and the rating results were averaged and the average value represents the human sensory rating results of the sample and the results are shown in TABLE 7. Smoothness test results are: 1 minute-coarse; 2—minute-coarser; 3—minute-generally; 4—minute-smoother; 5—minute-smooth. Softness test results are: 1—stiffness; 2—score-stiffer; 3—score-generally; 4—minute-softer; 5—minute-soft. The results of the touch-sensing cold-heating test are as follows: 1—ice-cooling; 2—ice-cooling; 3—way; 4—division-warmer; and 5—warm. The results of the wire slip test are as follows: 1 minute-dry; 2—minute-dry; 3—minute; 4—split-sticking; 5—split-sticking.

TABLE 7

| | | | | | Total | Divide | |
|---|---|---|---|---|---|---|---|
| | Smoothness | Softness | Warmth and coldness | Silkiness | score | equally | |
| Sample number | Score | Score | to the touch Score | Score | Score | Score | Judges |
| Example | 3 | 4 | 4 | 3 | 14 | 13.6 | Judge - 1 |
| 1 | 3 | 4 | 4 | 3 | 14 | | Judge - 2 |
| | 4 | 4 | 3 | 3 | 14 | | Judge - 3 |
| | 2 | 3 | 3 | 4 | 12 | | Judge - 4 |
| | 3 | 4 | 4 | 3 | 14 | | Judge - 5 |
| Fact | 5 | 4 | 4 | 4 | 17 | 15.8 | Judge - 1 |
| Implementation | 4 | 4 | 3 | 4 | 15 | | Judge - 2 |
| Example | 5 | 3 | 4 | 5 | 17 | | Judge - 3 |
| 1 | 4 | 2 | 3 | 5 | 14 | | Judge - 4 |
| | 5 | 3 | 4 | 4 | 16 | | Judge - 5 |

In the qualitative evaluation of the hand-feel test, the sample of Example 1 was even higher than the sample of Comparative Example 1 without a coating, i.e. Example 1 had a better feel. Quantitative Evaluation: According to the standard VDA 230-206 Stick-Slip Stick Test Standard in the German Automotive Industry, Test Instruments: Zins-Ziegler-Instruments Stick-Slip test stand SSP-04, Test Examples and Comparative Examples were subjected to Stick-Slip Testing. FIG. 34 shows the stick-slip test equipment, the test results are shown in FIGS. 35A-35B, 36A-36B, 37A-37B and 38A-38B and the specific test results are shown in TABLE 8.

TABLE 8

| | | | Maximum | Maximum |
|---|---|---|---|---|
| | Abnormal | Maximum | dynamic | static |
| Sample | noise | acceler- | friction | friction |
| number | level* | ation | coefficient | coefficient |
| Example 1 | Level 1 | 0.0882 | 0.3701 | 0.4252 |
| Example 2 | Level 1 | 0.0891 | 0.3662 | 0.4109 |
| Example 3 | Level 1 | 0.0835 | 0.3447 | 0.4357 |
| Example 4 | Level 1 | 0.0803 | 0.4231 | 0.3905 |
| Contrast | Level 9 | 1.8584 | 1.3992 | 1.7883 |
| ratio 1 | | | | |

Level: Comprehensive evaluation results of related parameters such as pulse rate, pulse value and maximum acceleration by software corresponding to the test instrument. The lower the grade value, the lower the performance of the measurement sample. As indicated schematically, from the stick-slip test results that the response level of Example 1 is Level 1 that is much lower than that of Comparative Example 1. For the test sample, the smaller the maximum acceleration of the surface, the smaller the dynamic friction and the static friction coefficient, the more the feel of the surface of the surface tends to slip. The maximum acceleration, the maximum dynamic friction coefficient and the maximum static friction coefficient of the surface of the sample in Example 1 are both lower than that of Comparative Example 1 and have a smoother feel.

### Exemplary Embodiments—Y

According to an exemplary embodiment shown schematically, a component for a vehicle interior comprising a composite structure may comprise a substrate/base and cover comprising base layer and cover layer configured to provide a surface effect such as visual effect and/or performance effect. The cover layer may comprise an applied material, formed/molded material, coating, treatment, laminate, film, etc.; the base layer may comprise a formed/molded material, polymer material, thermoplastic elastomer, foam/soft material, etc. The composite structure may comprise a multi-layer structure comprising a polymer material, fabric layer, non-woven layer, formed/molded materials, soft/cushion layer, barrier/intermediate layer in/at the cover, coating/treatment layer, etc. The substrate may comprise a structural substrate, formed/molded structure, panel, formed/molded panel, fiber panel, foam/resilient panel, composite panel, etc. The surface effect may comprise liquid repellence, durability/wear resistance, scratch resistance, stain resistance, anti-fouling, touch-feel/tactile performance, hardness/softness, friction coefficient, adhesion, decorative/color effect, etc.

According to an exemplary embodiment shown schematically, the component for a vehicle interior comprising the composite structure is configured to facilitate improvement of standards for vehicle/automotive consumers, including requirements for vehicle drivability and safety in context of vehicle interior environment requirements and upgrade; in-vehicle environment including vehicle interior decoration is of significance for improving user experience. As indicated schematically, for vehicle interior trim/components, surface effects and/or performance effect provided by a composite structure include soft and the surface tactile feel of the slip for a comfortable ride experience for the user; performance optimization of the interior trim/component may be achieved by a cover comprising a cover layer such as a film/layer and/or coating such as soft artificial leather; production may involve processing with increased manufacturing costs.

According to an exemplary embodiment as indicated schematically in the FIGURES, a composite structure for a component with cover may achieve advantages such as cost reduction and degree of freedom in modeling, environmentally friendly and recyclable materials selection, stain resistance, feel and wear resistance, etc.; as indicated, the composite structure with cover may provide surface anti-fouling treatment of thermoplastic injection molded skin/cover with a relatively simple treatment process and provide good stain resistance as well as surface effect of hand feel, scratch resistance and improvement of durability, etc.

### Antifouling Coatings:

1.1 Coating film-forming resin: water-based acrylic resin, water-based polyurethane resin
1.2 Coating auxiliary components: fluorine-containing polymers, silane-containing polymers
1.3 Solvent: water, isopropyl alcohol
1.4 Curing agent: isocyanate, carbide diamine
1.5 Others: leveling agent, defoamer, color paste, antioxidant, UV resistant additive

### Antifouling Coating Characteristics:

2.1 The coating cross-linking density of the film-forming resin is higher
2.2 Acrylic resin accounts for a high proportion
2.3 Fluorine-containing polymers and silicon-containing polymer materials are added
2.4 Dry film thickness of coating: 3~30 μm, preferably 8~15 μm

### 3. Thermoplastic Resin:

3.1 TPEE polyester elastomer
3.2 TPU polyurethane elastomers
3.3 TPV thermoplastic vulcanized elastomers
3.4 TPE-S thermoplastic styrene elastomer

### Thermoplastic Epidermis Preparation:

4.1 In-mold injection molding
4.2 In-mold foam injection molding
4.3 Extrusion and calendering
4.4 Slush process molding

### 5. Thermoplastic Resin Surface Treatment:

5.1 Before combining with the coating, the surface should be cleaned with solvent
5.2 Some skin materials require corona, fluorination or primer treatment

### 6. Spraying Process:

6.1 For the skin using the calendering process, the scraping process is adopted
6.2 For injection molded skin, the spraying process is adopted
6.3 Mix each component evenly in advance according to the proportion, or mix online
6.4 Scraping process, solid content ratio 40~80 percent
6.5 Spraying process, solid content ratio 20~40 percent
6.6 Baking conditions, 100~130 deg C, 3~20 min, post-curing 80 deg C, 10~40 min.

### 7. Adhesion Evaluation

7.1 Alcohol is wear-resistant, 10 round trips and the load is 1 kg.
7.2 Taber wear-resistant, 500 g, 500 times.

### 8. Stain Resistance Evaluation

8.1 Water droplet angle greater than 110 deg C.
8.2 Denim is wear-resistant and the grayscale grade ≥4

### 9. Feel Evaluation

9.1 Multi-person hand feel evaluation
9.2 Evaluation of static and dynamic friction coefficients

Chinese Utility Model No. CN215856916 U discloses an artificial leather having a pattern-like pattern that comprises a skin layer and a paint layer. A color brightening coating is provided on one side of the imitation leather pattern to improve the surface brightness of the artificial leather, so that the appearance effect of the imitation leather pattern is better.

The use of a soft rubber material (which is usually a thermoplastic elastomer) is used as a vehicle interior trim material that may provide a user with a good soft feel and increase comfort. However, due to the characteristics of the molecular structure of the soft rubber material and the product prepared by the soft rubber material, there may be a sticking feeling on the surface of the surface, and the scratch resistance and stain resistance of the component/product are poor and poor riding experience is brought to the user to a certain extent.

The present invention relates to a skin material for a vehicle, said material comprising: a skin layer that is formed by performing injection molding processing on a material containing a thermoplastic polyester elastomer and a coating layer that is located on the surface of the skin layer. As indicated schematically, through the design of the skin layer and coating layer, the obtained skin material has the advantages of excellent hand feel, scratch resistance, stain resistance, weather resistance and so on. According to an exemplary embodiment, the coating layer and the skin layer have strong bonding force and a good bonding effect. The preparation process of the skin material according to an exemplary embodiment is simple and environmentally friendly and said material has very good market application prospects.

TABLE A
REFERENCE SYMBOL LIST

| REFERENCE | |
|---|---|
| SYMBOL | ELEMENT, PART OR COMPONENT |
| V | Vehicle |
| VI | Vehicle Interior |
| C | Component |
| CS | Composite structure |
| | (e.g. comprising substrate, |
| | cover with base layer and cover layer, skin, etc.) |
| TX | Cover/skin layer for base layer and cover |
| | (e.g. formed, molded, injection-molded layer, etc.) |
| T | base layer for cover |
| | (e.g. base, resilient/soft layer, etc.) |
| SB | Substrate/base |
| | (e.g. structural substrate, structure, |
| | lightweight skeleton/structure, carrier, etc.) |
| TN | Intermediate/barrier layer/membrane for cover |
| | (e.g. formed, molded, injection-molded layer, etc.) |
| DP | Door Panel |
| FC | Floor Console |
| GB | Receptacle/Storage (Glove Box, etc.) |
| IP | Instrument Panel/Assembly |
| AR | Armrest/armrest assembly |
| VN | Visor/Vanity (Panel/Flap) |
| NKF | Frunk |
| NKR | Trunk |
| OHC | Overhead Console |
| OHP | Overhead Panel |
| PL | Pillar |
| PN | Panel |
| | (e.g. trim panel, fiber panel, formed panel, etc.) |
| SB | Substrate |
| SBa SBb | (e.g. structural substrate, base, base layer, structure, etc.) |
| SW | Steering Wheel/Assembly |
| SZ | Seat/Seat Assembly |
| T | Cover/cover base/layer |
| TB | Barrier layer |
| TN | Intermediate layer |
| TP | Coating (e.g. applied coating, film, etc.) |
| TX | Cover layer/Exterior Surface |
| WT | Liquid/liquid drops (e.g. water drops) |
| ZF | Force-applying tool/object (surface/performance effect) |
| M | Module |
| MD | Device |
| | (e.g. mobile device, object, etc.) |
| MT | Tool |
| | (e.g. mold, injection mold, press, oven, heater, etc.) |
| OB | Object |
| | (e.g. mobile device, object, item, etc.) |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for a vehicle interior comprising
a composite structure comprising
a substrate comprising a structural substrate; and
a cover provided on the substrate comprising a base layer and a cover layer;
wherein the cover layer comprises an exterior surface;
wherein the cover is configured to provide a surface effect at the exterior surface comprising a visual effect and/or a performance effect.

2. The component of claim 1 wherein the performance effect comprises stain resistance and/or fluid repellence and/or hardness and/or softness and/or scratch resistance and/or tactile performance and/or antifouling.

3. The component of claim 1 wherein the surface effect comprises adhesion evaluation and/or wear resistance and/or stain resistance evaluation and/or water droplet angle and/or feel evaluation and/or texture and/or static friction coefficient and/or dynamic friction coefficient.

4. The component of claim 1 wherein the visual effect comprises color and/or texture effect and/or grain effect.

5. The component of claim 1 wherein the surface effect is provided by the cover layer.

6. The component of claim 1 wherein the performance effect is provided by the cover layer and/or the base layer.

7. The component of claim 1 wherein the cover layer comprises a film and/or a coating and/or an exterior layer.

8. The component of claim 1 wherein the cover layer is formed on the base layer.

9. The component of claim 1 wherein the base layer comprises a molded layer comprising a polymer material and/or a molded material and/or an injection-molded material and/or a film and/or a polymer material and/or an elastomer and/or a thermoplastic elastomer and/or TPEE and/or TPU and/or TPV and/or TPE-S.

10. The component of claim 1 wherein the cover layer comprises a polymer material and/or a molded material and/or an injection-molded material and/or a film and/or a polyurethane material and/or an acrylic material comprising silicone and/or a polymer material comprising fluorine and/or a stain-resistant polymer material and/or polyacrylate and/or polyurethane and/or aziridine and/or isocyanate and/or carbodiimide and/or polyacrylic acid and/or methyl carboxylic acid methyl cellulose and/or acrylic fluoropolymer and/or organosiloxane polymer.

11. The component of claim 1 wherein the structural substrate comprises a panel and/or a base and/or a fiber panel and/or a compressed fiber panel and/or a reduced-density material and/or a stiffness-retaining material and/or a molded substrate and/or a composite panel and/or polymer material and/or a structure and/or hemp fiberboard and/or foamed hemp fiberboard and/or foamed glass fiberboard and/or polypropylene and/or polyimide and/or polycarbonate.

12. The component of claim 1 wherein the cover comprises a polymer material comprising a thermoplastic polyester elastomer comprising a hard segment and a soft segment.

13. The component of claim 1 wherein the cover comprises a polymer material configured for recyclability as a sub-assembly and selected from a group of polymer materials comprising a polyolefin group and/or a thermoplastic elastomeric group and/or an elastomeric group.

14. The component of claim 7 wherein the coating comprises a film-forming agent and crosslinking agent and/or solvent and anti-fouling agent and/or solvent and leveling agent and/or solvent and silane-based auxiliary agent and/or water or ethanol or isopropanol and/or polyacrylate or polyurethane or combination and/or aziridine or isocyanate or carbodiimide or combination and/or polyacrylic acid or methyl carboxylic acid methyl cellulose and/or an acrylic fluoropolymer or organosiloxane polymer or combination.

15. The component of claim 1 wherein the performance effect comprises liquid repellence and/or scratch resistance and/or stain resistance and/or abrasion resistance and/or gloss retention and/or a friction coefficient and/or adhesion and/or anti-fouling and/or weather resistance and/or a water droplet angle.

16. The component of claim 1 wherein the base layer comprises a polyethylene terephthalate fiber material and/or a nonwoven fabric material and/or a mesh fabric and/or foam material and/or sponge material and/or thermoplastic polyester elastomer and/or a foamed material and/or polyethylene terephthalate fiber nonwoven fabric.

17. The component of claim 1 wherein the cover comprises thermoplastic polyester elastomer and/or thermoplastic vulcanized rubber and/or polyurethane and/or a self-skinned material formed from thermoplastic polyester elastomer and/or a resilient material and/or a compressible material and/or a cushioning material and/or a foam material and/or a foam-based material and/or a film and/or polypropylene and/or polyethylene and/or polyethylene terephthalate and/or thermoplastic polyurethane elastomer and/or thermoplastic polyester elastomer and/or a laminate with the structural substrate and/or a skin layer formed from a thermoplastic polyester elastomer by an injection molding process and/or a coating on the base layer.

18. The component of claim 1 wherein the cover comprises an intermediate layer; wherein the intermediate layer comprises polypropylene and/or polyethylene and/or polyethylene terephthalate and/or thermoplastic polyurethane elastomer and/or thermoplastic polyester elastomer and/or a layer of material on one side of the base layer and/or a layer of material on each side of the base layer and/or a barrier layer; wherein the barrier layer is configured to limit penetration of material of the cover layer into material of the base layer during formation of the cover; wherein the barrier layer comprises a material having compatibility with material of the cover layer; and wherein the barrier layer comprises a laminate with the base layer.

19. The component of claim 1 produced by a method comprising the steps of:
providing a base layer material for the base layer of the cover;
providing the cover layer material for the cover layer on the base layer; and
providing the cover on the structural substrate;
wherein the step of providing the cover layer material on the base layer comprises forming the cover layer material on the base layer;
wherein the step of providing the base layer material comprises forming the base layer from the base layer material on the structural substrate; and
wherein the cover is configured to provide the surface effect for the composite structure.

20. The component of claim 19 wherein the method comprises injection molding to form the base layer of the cover and spray coating to form the cover layer of the cover.
